(19) United States
(12) Patent Application Publication
(10) Pub. No.: US 2009/0305899 A1
(43) Pub. Date: Dec. 10, 2009

(54) Compositions and methods for determining immune status

(75) Inventors: James Meegan, Woodbine, MD (US); Alex Tikhonov, Branford, CT (US); Barry Schweitzer, Branford, CT (US); Gengxin Chen, Branford, CT (US); Robert G. Ulrich, Frederick, MD (US)

Correspondence Address: VINSON & ELKINS L.L.P., First City Tower, 1001 Fannin Street, Suite 2300, HOUSTON, TX, 77002-6760, US

(73) Assignees: Invitrogen Incorporated, Carlsbad, CA (US); U.S. Army Medical Research and Material Command, Fort Detrick, MD (US)

(21) Appl. No.: 12/313,086

(22) Filed: Nov. 17, 2008

Related U.S. Application Data
(60) Provisional application No. 61/003,397, filed on Nov. 16, 2007.

(51) Int. Cl. C40B 20/00; C40B 40/10; C40B 30/04

(52) U.S. Cl. 506/2; 506/18; 506/9

(57) ABSTRACT

The present invention provides compositions and methods for identifying molecules in samples that bind to molecules associated with pathogenic agents (e.g., infectious agents). In certain aspects, the invention may be used to identify individuals that have been exposed to one or more pathogenic agent or have generated antibodies in response to one or more pathogenic agent. In other aspects, the invention is directed to the identification of molecules of one or more pathogenic agent that may be used to generate immune responses in other individuals.

### CROSS-REFERENCE TO RELATED APPLICATIONS

This application claims the benefit of U.S. Provisional Patent Application Ser. No. 61/003,397, filed on Nov. 16, 2007, which is incorporated herein by reference in its entirety.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of Contract Number W81XWH-05-2-0077 awarded by the United States Army Medical Research Institute of Infectious Diseases.

### THE NAMES OF PARTIES TO A JOINT RESEARCH AGREEMENT

N/A

### INCORPORATION-BY-REFERENCE OF MATERIAL SUBMITTED ON A COMPACT DISC

N/A

### BACKGROUND OF THE INVENTION

Historically, countries have tried to limit the spread of pathogenic agents. Many attempts at this have been made over centuries. In many instances, such measures have involved quarantining individuals known of having or suspecting of having the pathogenic agent. However, one early issue in controlling the spread of pathogenic agents is the identification of those individuals who carry the agent. In some aspects, the invention is intended to provide efficient means for the identification of these individuals.

One recent report discusses bacterial antigen microarray technology produced by covalent coupling of oligosaccharide antigens specific for several organisms. These microarrays are then used to identify antigen specific antibodies in sera of individuals. (Blixt, et al., Glycoconj. J. 25:27-36, 2008, Epub Jun. 9, 2007).

In other aspects, the invention provides means for identifying molecules of pathogenic agents, as well as regions of such molecules, against which individuals produce antibodies (e.g., protective antibodies).

### SUMMARY OF THE INVENTION

The invention provides compositions and methods for identifying molecules (e.g., antibodies) in samples (e.g., whole, blood, serum, cerebrospinal fluid, ascites, saliva, etc.) that bind to molecules (e.g., lipids, carbohydrates, proteins, etc.) associated with pathogenic agents (e.g., infectious agents). In some aspects, the invention may be used to identify individuals (e.g., humans, non-human animals (e.g., cows, chickens, ducks, pigs, mice, etc.), etc.) that have been exposed to one or more pathogenic agent (also referred to as a “pathogen”) or have generated antibodies (e.g., protective antibodies) in response to one or more pathogenic agent. In other aspects, the invention is directed to the identification of molecules of one or more pathogenic agent that may be used to generate immune responses (e.g., protective immune responses) in other individuals.

In various aspects, the invention includes collections of molecules. Molecules in such collections may be identical to one or more molecule from one or more pathogenic agent and/or may share structural similarity to one or more molecule from one or pathogenic agent (e.g., one or more pathogenic agent for which a vaccine exists). In many instances, when a molecule of such collections shares structural similarity to one or more molecule from one or pathogenic agent, the similarity will be such that the molecule of the collection either binds to antibodies (e.g., polyclonal or monoclonal) that bind to at least one of the one or more molecule the pathogenic agent.

In specific aspects, the invention includes compositions that comprise one or more (e.g., at least two, at least three, at least four, at least five, at least ten, at least fifteen, at least twenty, at least thirty, at least fifty, at least one hundred, at least three hundred, at least seven hundred, at least one thousand five hundred, at least four thousand, etc.; from about two to about five thousand, from about twenty to about five thousand, from about fifty to about five thousand, from about one hundred to about five thousand, from about two hundred to about five thousand, from about five hundred to about five thousand, from about fifty to about five thousand, from about fifty to about three thousand, from about fifty to about one thousand, from about twenty to about five thousand, from about twenty to about one thousand, etc.) protein (or other molecule such as a carbohydrate, DNA or RNA), each of which shares at least some structural features (e.g., similarity) with one or more molecule derived from one or more pathogenic agent. As examples, molecules used in the practice of the invention may be (1) located in separate locations on a solid support, located in separate containers (e.g., the individual wells of a microtiter plate, and/or (3) mixed together (e.g., two or more such as two to ten, three to ten four to ten, etc.) and contained in the same location and/or container.

When the molecule is a protein, molecules of the composition will typically share at least ten, at least twenty, at least thirty, at least fifty, at least seventy, at least one hundred (e.g., from about ten to about eighty, from about ten to about ninety, from about fifteen to about eighty, from about twenty to about eighty, from about thirty to about eighty, from about ten to about fifty, from about ten to about thirty, from about twenty to about fifty, etc.), etc. amino acids of sequence identity or similarity to a particular protein of a pathogenic agent. Of course, the full-length protein of the pathogenic agent may be used, as well as subportions of at least 20%, at least 30%, at least 40%, at least 50%, at least 60%, at least 70%, at least 80%, at least 85%, at least 90%, at least 95%, etc. of the full-length protein.

Any number of different pathogenic agents may be used in the practice of the invention. For example, the pathogenic agents may be one or more agent of a class selected from the group consisting of a protozoan, a virus, a viroid, a bacterium, and a parasite (e.g., a multicellular parasite, such as a worm).

Any number of different solid supports may be used in the practice of the invention. Examples of solid support comprises include those composed of one or more material selected from the group consisting of nitrocellulose, diazocellulose, glass, polystyrene, polyvinylchloride, polypropylene, polyethylene, polyvinyldifluoride and nylon.

Further, compositions of the invention may contain any number of molecules. For example, when the invention is a composition comprising a solid support, this solid support may contain from about two to about four thousand molecules (e.g., proteins), from about two to about three thousand molecules, from about two to about two thousand molecules, from about two to about one thousand molecules, from about one hundred to about five thousand molecules, from about one hundred to about four thousand molecules, or from about one hundred to about one thousand molecules.

The number of pathogenic agents represented in compositions of the invention can vary considerably. For example, when the invention is directed to a solid support that contains proteins, the solid support may contain proteins that share sequence identity with at least one protein from about two to about two hundred, from about two to about four hundred, from about five to about two hundred, from about ten to about two hundred, from about twenty to about two hundred, from about thirty to about two hundred, or from about forty to about two hundred different pathogenic agents. Of course, compositions of the invention could contain other molecules instead of proteins or may contain different types of molecules (e.g., some spots of microarray could contain proteins and other could contain polysaccharides). Specific examples of classes of pathogenic agents are those in the following groups: human immunodeficiency virus, Mycobacteria, Chlamydia, Shigella, Treponema, Rickettsia, hemorrhagic fever viruses, and human papilloma viruses.

Mycobacterium species that may be used in the practice of the invention include Mycobacterium tuberculosis, Mycobacterium szulgai, Mycobacterium smegmatis, Mycobacterium marinum, Mycobacterium bovis, Mycobacterium caprae, Mycobacterium simiae, Mycobacterium terrae, Mycobacterium neoaurum, Mycobacterium simiae, Mycobacterium avium, Mycobacterium parascrofulaceum, Mycobacterium gordonae, and Mycobacterium leprae.

Other organisms that may be used in the practice include those of the following genera/species: Bacillus (e.g., Bacillus anthracis), Candida (e.g., Candida albicans, Candida guilliermondii, Candida glabrata, Candida tropicalis, etc.), Porphyromonas (e.g., Porphyromonas gingivalis), Ochrobactrum (e.g., Ochrobactrum anthropi), Helicobacter (e.g., Helicobacter pylori), Staphylococcus (e.g., Staphylococcus aureus), and Mycoplasma (e.g., Mycoplasma pneumoniae, Mycoplasma bovis, Mycoplasma bovigenitalium, Mycoplasma gallisepticum, Mycoplasma bovigenitalium, Mycoplasma pulmonis, etc.).

Molecules may be linked to solid supports by any number of methods. These linkages may be covalent or non-covalent (e.g., ionic, hydrophobic, hydrophilic, etc.). Further, molecules may be affixed to solid supports in such a way as to form an array. Molecules may be located in discrete locations in a line or in a series of rows and columns. One format for an array is shown in FIG. 1A and FIG. 1B.

The invention also relates to methods for determining immune status of individuals. Immune status may be determined for any number of purposes and may be used, for example, to determine whether individuals have been exposed to one or more pathogenic agent or to determine whether vaccination(s) have resulted in the generation of immunological response(s) (e.g., protective immunological response(s)). In specific embodiments, methods of the invention include those for determining immune status in one or more individual with respect to one or more, two or more, three or more, or four or more (e.g., one to twenty, two to twenty, three to twenty, four to twenty, five to twenty, eight to twenty, twelve to twenty, ten to fifty, fifteen to fifty, twenty to fifty, ten to eighty, etc.) pathogenic agents. With respect to one individual, such methods may comprise: (a) obtaining a sample from the individual; (b) contacting the sample with a solid support as described herein; and (c) identifying locations on the solid support to which antibodies bind, thereby determining immune status. The invention also provides methods for determining whether molecules induce immunological responses.

The invention also includes method for identifying molecules that induce immunological responses in individuals. In particular aspects, such methods include those for identifying one or more molecule that induces an immunological response in an individual. Exemplary methods comprise: (a) either (i) contacting the individual with a pathogenic agent or one or more biological material from the pathogenic agent or (ii) selecting the individual on the basis of past exposure to the pathogenic agent; (b) obtaining a sample from the individual; (c) contacting the sample with a solid support, wherein the solid support contains molecules as described herein; and (d) identifying the binding of antibodies to locations on the solid support, thereby identifying one or more molecule that induces an immunological response in the individual.

In many instances, methods discussed herein with include controls. In one aspect, such control may include obtaining a sample from an individual prior to contacting of the individual with molecules of pathogenic agents. This sample may then be screened to identify antibodies present before the individual is contacted with the molecules of the pathogenic agents. These antibodies may then be subtracted from the data set.

Locations on arrays may contain more than one molecule or one or more mixtures of molecules. For example, a single location (e.g., spot) on an array may contain two different proteins and a carbohydrate from the same pathogen. In many instances, such a location would be designed to bind antibodies induced by the pathogen. One purpose for mixing such molecules is to identify samples that contain antibodies specific for the pathogen, when it is not necessary to know exactly what molecule has induced the immune response in the individual from which the sample has been obtained. Another example is where molecules from different pathogens are located in a single location on an array. In many cases, such a location on an array may be used to determine immunological status or prior contact with one of a number of pathogens such as different types of human immunodeficiency viruses. As an initial screen, it may not be necessary to determine which member(s) of the pathogenic agent class represented in the location the individual has been exposed to. One advantage of using arrays as described above is that they reduce costs and require smaller samples. Thus, the invention includes multi-level screening of samples from individual, wherein at the first level of screening an array as described immediately above is employed, followed by more “specific” arrays are used, as necessary, in the second level. One example of a “specific” array is that shown in FIG. 1A and FIG. 1B. This array contains “spots” that each contain a single molecule, each corresponding to a molecule from single pathogen.

Locations on arrays may contain may also contain mixtures of molecules. Such mixtures may be derived from any number of sources. For example, locations on arrays may contain cell extracts, viral extracts, or molecules that are given off (e.g., molecules that may be obtained from culture media that has been in contact with pathogenic agents, such as a conditioned medium) by one or more pathogenic agents. Cell extracts may be prepared from cells that contain one or more molecules capable of binding at least one antibody produced in response to one or more pathogenic agent. As an example, a cell line may be constructed that expresses domains of two different proteins of a pathogenic agent. A cell extract, as well as other composition referred to above, may be prepared and used to generate a location on an array.

When a mixture of molecules is positioned in a spot, these molecules may be from the same pathogenic agent or from one or more pathogenic agents. Further, these mixtures of molecules may be prepared by combining purified (e.g., partially purified) molecules or by application to the array of a cell extract (e.g., a cell extract from cells infected with a single pathogenic agent or multiple different pathogenic agents). Such cell extracts may be prepared by introducing nucleic acids into the cells (e.g., by transfection, transduction, infection, etc.), followed by lysis of the cells. Further, cell extracts may be combined in a single spot (e.g., mixed before application to an array or spotted in the same location).

Locations on arrays may also contain vaccine compositions (with or without adjuvants being present). The presence of a vaccine composition on an array may be advantageous when one seek to determine whether an immunological response has been directed against one or more of the vaccine's components. Thus, in this aspect, the invention is directed to methods and compositions for determining whether a particular vaccine has directed an immunological response to one or more component of the vaccine. Of course, the presence of such a response does not necessarily indicate the induction of protective immunity by the vaccine.

In addition to cell extracts, locations on arrays may contain one or more virus (e.g., heat killed virus). For example, array spots may contain two or more (e.g., two, three, four, five, etc.) related viruses (e.g., influenza viruses) that are different strains.

The invention also includes methods and compositions for characterizing host responses to pathogens, as well as nonpathogens. Such host responses may then be analyzed for any number of purposes. As an example, an organism's “fingerprint” may be identified. One type of fingerprint would be the induction of production of antibodies with specificity for particular proteins and/or regions of particular proteins. Fingerprints may be used to identify biomarkers, identify individuals with current exposure (e.g., infected individuals), or identify individual with past exposure to one or more organisms or interest (e.g., pathogens).

Along the lines of the above, the invention also provides methods and compositions for identifying pathogen molecules that are capable of inducing the production of antibodies that cross-react with host molecules. Thus, the invention also relates to the identification of molecules that are capable of inducing, for example, autoimmune responses in individuals that harbor the organism.

### BRIEF DESCRIPTION OF THE FIGURES

The following drawings form part of the present specification and are included to further demonstrate certain aspects of the present invention. The invention may be better understood by reference to one or more of these drawings in combination with the detailed description of specific embodiments presented herein.

FIG. 1A and FIG. 1B. Exemplary compositions of the invention. FIG. 1A shows the composition, in this case a microarray, before contact with a sample. The twenty-four spots to the far left, in columns 1-4 (Section 1) and identified by vertically hatched circles, represent locations of proteins from different species and strains of Mycobacteria. The spots in columns 5-8 (Section 2) and identified by open circles represent the locations of proteins that are bound by antibodies generated in response to common vaccines. The spots in columns 9-10 (Section 3) and identified by stippled circles represent the locations of proteins that are bound by antibodies generated in response to immunodeficiency viruses such as HIV and HTLV. The twenty-four spots to the far right, in columns 11-14 (Section 4) and identified by horizontally hatched circles, represent locations of proteins from different species and strains of bacteria associated with sexually transmitted diseases (e.g., Treponema pallidum, Chlamydia trachomatis, human papilloma viruses, etc.). The bar code at the right can encode specific information, for example the individual being tested, the date, the test location, etc. FIG. 1B shows the same microarray after contact with a sample, with solid black circles representing “positives”.

FIG. 2A, FIG. 2B, and FIG. 2C. A schematic of methods of the invention as applied to vaccine development. In this embodiment, an immunological response induced by a known vaccine is compared to immunological responses induced by test vaccines. FIG. 2A represents an immunological response (“good” antibody profile) induced in humans by a known (licensed) vaccine. Historically, this vaccine was known to protect against smallpox in the years before smallpox was eradicated. FIG. 2B represents an immunological response (“good” antibody profile) induced in humans by a new vaccine that cannot be definitively tested for protection against human smallpox. FIG. 2C represents an immunological response (“poor” antibody profile) induced in humans by a new vaccine that is unlikely to fully protect.

FIG. 3. An “antibody fingerprint” for multiple pathogenic agents, in this example influenza A (row 1), influenza B (row 2), tularemia (row 3), SARS (row 4), avian flu (row 5), dengue (row 6), rubella (row 7), polio (row 8), and mumps (row 9). Positive reaction indicated by filled circles, intermediate reaction indicated by stippled circles, no reaction indicated by open circles.

FIG. 4A, FIG. 4B, and FIG. 4C. One use of arrays of the invention. In this embodiment, arrays are used to determine whether an individual is infected with a pathogen and, if so, what is the stage of infection. FIG. 4A represents the array profile of a healthy individual. FIG. 4B represents the array profile of a pre-symptomatic infected individual. FIG. 4C represents the array profile of an individual with early stage disease.

FIG. 5. One use of arrays of the invention. In this embodiment, arrays are used to determine whether an individual is infected with a pathogen and, if so, what specific serotype of the pathogen. The pathogens used in this example are dengue type 1 (row 1), dengue type 2 (row 2), dengue type 3 (row 3), dengue type 4 (row 4), influenza A (row 5), hantavirus (row 6), polio (row 7), and plague (row 8). Positive reaction indicated by filled circles, no reaction indicated by open circles.

FIG. 6A and FIG. 6B. One use of arrays of the invention. In this embodiment, arrays are used to determine whether an individual is infected with a pathogen at an early in life time point and then used to monitor exposure to pathogens later in life. The pathogens used in this example are influenza A (row 1), influenza B (row 2), tularemia (row 3), SARS (row 4), avian flu (row 5), dengue (row 6), hantavirus (row 7), polio (row 8), and plague (row 9). Positive reaction indicated by filled circles, no reaction indicated by open circles. FIG. 6A represents an individual's immunological history at a time point early in life, and shows exposure to influenza A (row 1), influenza B (row 2), and polio (row 8). FIG. 6B represents an individual's immunological history at a time point later in life, and in addition to exposure to influenza A (row 1), influenza B (row 2), and polio (row 8), shows more recent exposure to avian flu (row 5) and dengue (row 6).

FIG. 7A, FIG. 7B, and FIG. 7C. One use of arrays of the invention. In this embodiment, arrays are used to determine whether an individual or animal is infected with a pathogen, has been immunized against the pathogen, and individuals that have neither been infected nor immunized against the pathogen. FIG. 7A represents the array profile of an individual or animal that is naturally infected. FIG. 7B represents the array profile of an individual or animal that has been immunized. FIG. 7C represents the array profile of an individual or animal that has not been immunized or infected.

### DETAILED DESCRIPTION OF THE INVENTION

Compositions of the invention may be designed for any number of purposes. As examples, compositions may be designed to screen samples for antibodies associated with generation of protective immunity and/or exposure to one or more pathogenic agent. Such compositions may be used in methods for identifying individuals (e.g., humans or animals) that pose a potential infectious threat to others in a population (e.g., a community of humans or a group of animals (e.g., domesticated or animals in the wild)). As an example, when a pathogenic agent (e.g., an infectious agent) is known or suspected to be present in a region, individuals in or traveling from that region may be tested for signs of contact with that pathogenic agent.

The invention further includes methods for testing individuals seeking to enter a particular region (e.g., a country such as the United States or an association of countries such as the European Union) show signs associated with contact with a pathogenic agent. Such methods may include identifying individuals wishing to enter a particular region and using compositions and methods set out herein to determine whether those individuals have been exposed to one or more pathogenic agent. Individuals who test positive may then be sequestered from others in the population, refused entry into the region, subjected to further testing (e.g., to confirm the presence of the pathogenic agent, for example, by PCR or culture), and/or treated for the pathogenic agent.

Protein arrays for Yersinia pestis and vaccinia have been produced and validated. These arrays function well and provide substantial amounts of quantitative and qualitative data on the individual's response to infection and/or immunization. These arrays are useful for rapid diagnostic assays and in uncovering protein-protein interactions that occur between host and pathogenic agent during the infective cycle. These interactions might represent unique targets for the development of antimicrobials.

It has recently become possible to analyze the activities of thousands of proteins using protein microarrays (MacBeath and Schreiber, Science 289:1760-1763, 2000; Zhu, et al., Science 293:2101-2105, 2001, Epub Jul. 26, 2001). Protein microarrays contain defined sets of proteins and can be generally classified into two types—protein profiling arrays and functional protein arrays. Protein profiling arrays, which have been reviewed elsewhere (Schweitzer and Kingsmore, Curr. Opin. Biotechnol. 13:14-19, 2002), usually consist of multiple antibodies printed on glass slides and are used to measure protein abundance and/or alterations. Functional protein arrays can be made up of any type of protein, and therefore have a more diverse set of useful applications. Some of the advantages of these protein microarrays include low reagent consumption, rapid interpretation of results, and the ability to easily control experimental conditions. One advantage, however, is the ability to rapidly and simultaneously screen large numbers of proteins for biochemical activities, protein-protein interactions, protein-lipid interactions, protein-nucleic acid interactions, and protein-small molecule interactions. Using these arrays, one can, in a single experiment, determine all of the substrates for a protein-modifying enzyme, build an entire protein interaction network, or determine all of the potential binding partners in a cell for a drug under development. The invention thus includes methods for (1) identifying substrates for a protein-modifying enzyme, (2) identifying components of entire protein interaction networks (e.g., which proteins interacted with particular members of such networks), and (3) identifying binding partners for cells.

One ultimate form of a functional protein array consists of all of the proteins encoded by the genome of an organism; such an array is the “whole proteome” equivalent of the whole genome arrays that are now available. Snyder and coworkers recently described the preparation of a functional, protein microarray that closely approaches this ideal (Zhu, et al., 2001, supra). More than 80% of the 6280 annotated (Snyder and Gerstein, Science 300:258-260, 2003) genes from the yeast Saccharomyces cerevisiae genome were cloned, over expressed, purified and arrayed in an addressable format on glass slides. This work represented the first time that the majority of proteins in a proteome had been individually isolated and transferred simultaneously to a solid surface. This “whole-proteome” microarray was launched commercially by Invitrogen Corporation (Carlsbad, Calif.) in 2004 (see, e.g., catalog nos. PA012106 and PA0121065). Since that time, Invitrogen Corporation has developed and launched an array containing thousands of purified human proteins (Sheridan, Nat. Biotechnol. 23:3-4, 2005) (see, e.g., catalog nos. PAH052406 and PAH0524065). These arrays have proven to be a powerful tool for high-throughput and comprehensive measurements of protein-protein, protein-antibody, and protein-small molecule interactions (Zhu, et al., 2001, supra; Ball, et al., Nucleic Acids Res. 33:D580-D582, 2005).

Any number of variations of proteome array (e.g., Yersinia pestis arrays, Fransicella tularensis arrays, Bacillus anthracis arrays, etc.) may be used in the practice of the invention. For example, in one aspect, the invention includes a poxvirus multi-proteome array composed of proteins from Vaccinia and monkey pox (Zaire and WRAIR strains). Such arrays may be used, for example, for the identification of protein that, when located on an array, can be used to diagnose poxvirus infections. Thus, diagnostic markers and/or protective antigens may be identified by methods of the invention.

The invention is directed, in part, to methods for detecting mammalian immune responses to pathogens, including several hemorrhagic viruses, poxviruses and B. anthracis. These methods include those that involve translating proteins from pathogen genes (the “patheome”) and creating microarrays with these proteins. These types of arrays, also known as immunoarrays, may be used to determine if an immune response has been elicited due to vaccination and/or infection. In the case of vaccination, this will assist in development of new vaccines, determine if an individual has a modicum of protection, and establish a method to measure population resistance/susceptibility. In the case of infection, future generations of this product may also be useful as diagnostic tools. Arrays described herein also hold promise of being useful in uncovering protein-protein interactions that might represent unique targets for the development of future antimicrobials.

One of the most difficult tasks in developing a recombinant protein subunit vaccine or DNA vaccine or when selecting an antigen or set of antigens to use for diagnostic and/or immune status monitoring purposes is the identification of the antigens capable of stimulating the most effective immune response against the pathogen, particularly when the genome of the organism is large.

The genomes of many infectious organisms have been sequenced and annotated, but no algorithm are currently available that can be used effectively to identify the target antigens or epitopes of protective T cell and antibody responses from the genomic sequence data alone. One approach to this problem of antigen identification was reported recently in which bioinformatics were used to prioritize 570 antigens from the bacteria Neisseria meningitidis, which encodes 4,000 ORFs (Pizza, et al., Science 287:1816-1820, 2000; Tettelin, et al., Science 287:1809-1815, 2000). A large-scale conventional cloning and expression approach led to the purification of 350 candidate antigens, which were used to immunize mice, and the antigens that produced bactericidal antibodies were identified. A comprehensive way to accomplish this task would be to obtain each of the structural, metabolic, and regulatory antigens of the pathogen and test their protective immunity or diagnostic utility individually or as mixtures. Although this approach may work for small viruses encoding several antigens, it is not practical for large viruses like smallpox or even for simultaneous assay of multiple small viruses encoding several antigens. It is certainly not feasible for bacteria like B. anthracis, which encode thousands of antigens, to test these antigens one at a time. Methods of the invention include those that involve the use of arrays for identifying proteins that are capable of inducing immune responses in individuals. In certain aspects such methods involve obtaining a sample from an individual exposed to a pathogenic agent, followed by identification of antibodies that bind to molecules of the pathogenic agent. These molecules, or subportions thereof, of the pathogenic agent are vaccine candidates. This is especially the case where the individual from which the sample obtained from has protective immunity to the pathogenic agent.

One approach for accelerating the pace of development in this area is to study the entire proteomes of these organisms. In addition to providing a comprehensive approach to vaccine and diagnostic development, proteome-scale studies can be used to provide fundamental information about pathogens including protein expression, subcellular localization, biochemical activities, and protein pathways. There are a variety of approaches for simultaneously studying large numbers of proteins and protein variants, including two-dimensional gel electrophoresis, mass spectroscopy, and combinations of mass spectroscopy with liquid chromatography (reviewed in Michaud, et al., Nat. Biotechnol. 21:1509-1512, 2003, Epub Nov. 9, 2003). Such methods have found important applications in the areas of basic biological research, drug target and disease marker identification, and in drug development. The problems with these technologies are that they are time-consuming, require expensive and specialized equipment as well as considerable expertise to run the equipment, and also utilize large amounts of sample.

Recently, Felgner and coworkers described the development of a proteome-scale poxvirus microarray (Davies, et al., Proc. Natl. Acad. Sci. USA 102:547-552, 2005(a), Epub Jan. 12, 2005, Davies, et al., J. Virol. 79:11724-11733, 2005(b)). In this report, 185 out of the 273 proteins encoded by the vaccinia genome were expressed in an Escherichia coli-based cell-free in vitro transcription/translation system, and the crude reactions containing expressed proteins were printed directly onto microarrays without purification. The chips were used to determine antibody profiles in serum from vaccinia virus-immunized humans, primates, and mice. Naive humans exhibit reactivity against a subset of 13 antigens that were not associated with vaccinia immunization, but naive mice and primates lacked this background reactivity. The specific profiles between the three species differed, although a common subset of antigens was reactive after vaccinia immunization. Although this study demonstrated the potential of this technology to comprehensively scan humoral immunity from vaccinated or infected humans and animals, it suffered from a number of serious drawbacks including the lack of quality control (e.g., DNA sequencing or Western blotting) on the cloned genes or expressed proteins, the use of non-purified proteins, and the use of a bacterial host to express proteins from a non-bacterial organism. Not surprisingly, the authors reported high background and relatively low signals in experiments using human sera (Davies et al., 2005(a) and (b), supra).

Protein Production

Methods are known to clone open reading frames into vectors, such as baculoviral vectors, such that a promoter on the vector directs expression of a fusion protein comprising the open reading frame linked to a tag. The open reading frame can be cloned from virtually any source including genomic DNA and cDNA. In certain aspects, the open reading frame is cloned into a vector such that it is in frame with the tag. In certain aspects, the multiple open reading frames may be cloned into a vector such that a complex comprising more than one subunit open reading frame products is formed in the insect cells and purified using a tag on at least one of the proteins of the multi-protein complex (see e.g., Berger, et al., Nat. Biotechnol. 22:1583-1587, 2004).

A variety of tags (e.g., heterologous domains, with affinity for a compound) are known in the art and can be used. Accordingly, in an illustrative embodiment, proteins of the positionally addressable array of proteins may be expressed as fusion proteins having at least one tag that is attached to the surface of the solid support and/or that is used to purify the protein using, for example, affinity chromatography. Suitable compounds useful for binding fusion proteins onto the solid support (i.e., acting as binding partners) include, but are not limited to, trypsin/anhydrotrypsin, glutathione, immunoglobulin domains, maltose, nickel, or biotin and its derivatives, which bind to bovine pancreatic trypsin inhibitor, glutathione-S-transferase, Protein A or antigen, maltose binding protein, poly-histidine (e.g., HisX6 tag), and avidin/streptavidin, respectively. For example, Protein A, Protein G and Protein A/G are proteins capable of binding to the Fc portion of mammalian immunoglobulin molecules, especially IgG. These proteins can be covalently coupled to, for example, a SEPHAROSE® support to provide an efficient method of purifying fusion proteins having a tag comprising an Fc domain.

In certain aspects of the invention, at least 2 tags are present on the protein, one of which can be used to aid in purification and the other can be used to aid in immobilization. In certain illustrative aspects, the tag is a His tag, a GST tag, or a biotin tag. Where the tag is a biotin tag, the tag can be associated with a protein in vitro or in vivo using commercially available reagents (Invitrogen Corporation). In aspects where the tag is associated with the protein in vitro, a BIOEASE™ tag can be used (Invitrogen Corporation).

In certain examples, a eukaryotic cell (e.g., yeast, human cells) may be used to synthesize eukaryotic proteins. Further, a eukaryotic cell amenable to stable transformation, and having selectable markers for identification and isolation of cells containing transformants of interest, may be used. Alternatively, a eukaryotic host cell deficient in a gene product is transformed with an expression construct complementing the deficiency. Cells useful for expression of engineered viral, prokaryotic or eukaryotic proteins are known in the art, and variants of such cells can be appreciated by one of ordinary skill in the art. The cells can include yeast, insect, and mammalian cells. In certain aspects, corn cells are used to produce the recombinant human proteins.

For example, the INSECTSELECT™ system from Invitrogen Corporation (catalog no. K800-01), a non-lytic, single-vector insect expression system that simplifies expression of high-quality proteins and eliminates the need to generate and amplify virus stocks, can be used. An illustrative vector in this system is pIB/V5-His TOPO TA vector (catalog no. K890-20). Polymerase chain reaction (“PCR”) products can be cloned directly into this vector, using the protocols described by the manufacturer, and the proteins can be expressed with N-terminal histidine tags useful for purifying the expressed protein.

Another eukaryotic expression system in insect cells, the BAC-TO-BAC™ system (Invitrogen Corporation), can also be used. Rather than using homologous recombination, the BAC-TO-BAC™ system generates recombinant baculovirus by relying on site-specific transposition in E. coli. Gene expression is driven by the highly active polyhedrin promoter, and therefore can represent up to 25% of the cellular protein in infected insect cells. In another aspect, a BACULODIRECT™ Baculovirus Expression System (Invitrogen Corporation) is used.

In certain aspects, each open reading frame is initially cloned into a recombinational cloning vector such as a GATEWAY™ entry vector, and then shuttled into a baculovirus vector. Methods are known in the art for performing these cloning and shuttling experiments. The open reading frame can be partially or completely sequenced to assure that sequence integrity has been maintained, by comparing the sequence to sequences available from public or private databases of human genes.

In certain examples, the open reading frame can be cloned into a GATEWAY™ entry vector (Invitrogen Corporation) or cloned directly into pDEST20 (Invitrogen Corporation). In other aspects, the entry vector and/or the pDEST20 vector are linearized, for example using BssII, before or during a recombination reaction. In certain aspects, an open reading frame cloned into a pDEST20 vector can be transfected directly into DH10Bac cells. Alternatively, a vector can be constructed with the important functional elements of pDEST20 and used to transfect DH10Bac cells directly. An open reading frame of interest can be cloned directly into the vector using, for example, restriction enzyme cleavages and ligations.

Systems are available for expressing open reading frames in baculovirus. For example, insect cells are typically used for this expression. Any host cell that can be grown in culture can be used to synthesize the proteins of interest. Host cells may be used that can overproduce a protein of interest, resulting in proper synthesis, folding, and posttranslational modification of the protein. In some instances, such protein processing forms epitopes, active sites, binding sites, etc. useful for assays to characterize molecular interactions in vitro that are representative of those in vivo.

In certain illustrative embodiments, the host cell is an insect host cell. A variety of insect cells are commercially available (see, e.g., Invitrogen Corporation). The cells can be, for example, Hi-5 cells (available from the University of Virginia, Tissue Culture Facility), sf9 cells (Invitrogen Corporation), or SF21 cells (Invitrogen Corporation). In certain illustrative embodiments, the insect cells are sf9 cells. In a particular embodiment, yeast cultures are used to synthesize eukaryotic fusion proteins. In one aspect, the yeast Pichia pastoris is used. Fresh cultures may be used for efficient induction of protein synthesis, especially when conducted in small volumes of media. Also, care is normally taken to prevent overgrowth of the yeast cultures. In addition, yeast cultures of about 3 ml or less may be used to yield sufficient protein for purification. To improve aeration of the cultures, the total volume can be divided into several smaller volumes (e.g., four 0.75 ml cultures can be prepared to produce a total volume of 3 ml).

Cells may then be contacted with an inducer (e.g., galactose) and harvested. Induced cells are washed with cold (e.g., 4° C. to about 15° C.) water to stop further growth of the cells, and then washed with cold (e.g., 4° C. to about 15° C.) lysis buffer to remove the culture medium and to precondition the induced cells for protein purification, respectively. Before protein purification, the induced cells can be stored frozen to protect the proteins from degradation. In a specific embodiment, the induced cells are stored in a semi-dried state at −80° C. to prevent or inhibit protein degradation.

Cells can be transferred from one array to another using any suitable mechanical device. For example, arrays containing growth media can be inoculated with the cells of interest using an automatic handling system (e.g., automatic pipette). In a particular embodiment, 96-well arrays containing a growth medium comprising agar can be inoculated with yeast cells using a 96-pronger. Similarly, transfer of liquids (e.g., reagents) from one array to another can be accomplished using an automated liquid-handling device (e.g., Q-FILL™, Genetix, UK).

Although proteins can be harvested from cells at any point in the cell cycle, cells may be isolated during logarithmic phase when protein synthesis is enhanced. For example, yeast cells can be harvested between OD₆₀₀=0.3 and OD₆₀₀=1.5, in particular between OD₆₀₀=0.5 and OD₆₀₀=1.5. In a particular embodiment, proteins are harvested from the cells at a point after mid-log phase. Harvested cells can be stored frozen for future manipulation.

The harvested cells can be lysed by a variety of methods known in the art, including mechanical force, enzymatic digestion, and chemical treatment. The method of lysis should be suited to the type of host cell. For example, a lysis buffer containing fresh protease inhibitors is added to yeast cells, along with an agent that disrupts the cell wall (e.g., sand, glass beads, zirconia beads), after which the mixture is shaken violently using a shaker (e.g., vortexer, paint shaker). In a specific embodiment, zirconia beads are contacted with the yeast cells, and the cells lysed by mechanical disruption by vortexing. In a further embodiment, lysing of the yeast cells in a high-density array format is accomplished using a paint shaker. The paint shaker has a platform that can firmly hold at least eighteen 96-well boxes in three layers, thereby allowing for high-throughput processing of the cultures. Further the paint shaker violently agitates the cultures, even before they are completely thawed, resulting in efficient disruption of the cells while minimizing protein degradation. In fact, as determined by microscopic observation, greater than 90% of the yeast cells can be lysed in less than two minutes of shaking.

The resulting cellular debris can be separated from the protein and/or other molecules of interest by centrifugation. Additionally, to increase purity of the protein sample in a high-throughput fashion, the protein-enriched supernatant can be filtered, for example, using a filter on a non-protein-binding solid support. To separate the soluble fraction, which contains the proteins of interest, from the insoluble fraction, use of a filter plate may be employed to reduce or avoid protein degradation. Further, these steps may be repeated on the fraction containing the cellular debris to increase the yield of protein.

Proteins can then be purified from a protein-enriched cell supernatant using a variety of affinity purification methods known in the art. Affinity tags useful for affinity purification of fusion proteins by contacting the fusion protein preparation with the binding partner to the affinity tag, include, but are not limited to, calmodulin, trypsin/anhydrotrypsin, glutathione, immunoglobulin domains, maltose, nickel, or biotin and its derivatives, which bind to calmodulin-binding protein, bovine pancreatic trypsin inhibitor, glutathione-S-transferase (“GST tag”), antigen or Protein A, maltose binding protein, poly-histidine (“His tag”), and avidin/streptavidin, respectively. Other affinity tags can be, for example, myc or FLAG. Fusion proteins can be affinity purified using an appropriate binding compound (I.e., binding partner such as a glutathione bead), and isolated by, for example, capturing the complex containing bound proteins on a non protein-binding filter. Placing one affinity tag on one end of the protein (e.g., the carboxy-terminal end), and a second affinity tag on the other end of the protein (e.g., the amino-terminal end) can aid in purifying full-length proteins.

In a particular embodiment, the fusion proteins have GST tags and are affinity purified by contacting the proteins with glutathione beads. In further embodiment, the glutathione beads, with fusion proteins attached, can be washed in a 96-well box without using a filter plate to ease handling of the samples and prevent cross contamination of the samples. In addition, fusion proteins can be eluted from the binding compound (e.g., glutathione bead) with elution buffer to provide a desired protein concentration. In a specific embodiment, fusion proteins are eluted from the glutathione beads with 30 ml of elution buffer to provide a desired protein concentration.

For purified proteins that will eventually be spotted onto microscope slides, the glutathione beads are separated from the purified proteins. In some instances, all of the glutathione beads are removed to avoid blocking of the positionally addressable arrays pins used to spot the purified proteins onto a solid support. In one embodiment, the glutathione beads are separated from the purified proteins using a filter plate, optionally comprising a non-protein-binding solid support. Filtration of the eluate containing the purified proteins should result in greater than 90% recovery of the proteins.

The elution buffer may comprise a liquid of high viscosity such as, for example, 15% to 50% glycerol, or about 25% glycerol. The glycerol solution stabilizes the proteins in solution, and prevents dehydration of the protein solution during the printing step using a positionally addressable arrayer.

The elution buffer may comprise a liquid containing a non-ionic detergent such as, for example, 0.02-2% Triton-100, or about 0.1% Triton-100. The detergent promotes the elution of the protein during purification and stabilizes the protein in solution.

Purified proteins may be stored in a medium that stabilizes the proteins and prevents desiccation of the sample. For example, purified proteins can be stored in a liquid of high viscosity such as, for example, 15% to 50% glycerol, or in about 40% glycerol. In some instances, it is desirable to aliquot samples containing the purified proteins, so as to avoid loss of protein activity caused by freeze/thaw cycles.

The skilled artisan can appreciate that the purification protocol can be adjusted to control the level of protein purity desired. In some instances, isolation of molecules that associate with the protein of interest is desired. For example, dimers, trimers, or higher order homotypic or heterotypic complexes comprising an overproduced protein of interest can be isolated using the purification methods provided herein, or modifications thereof. Furthermore, associated molecules can be individually isolated and identified using methods known in the art (e.g., mass spectroscopy).

Typically a quality control step is performed to confirm that a protein expressed from the open reading frame is isolated and purified. For example, an immunoblot can be performed using an antibody against the tag to detect the expressed protein. Furthermore, an algorithm can be used to compare the size of the expressed protein with that expected based on the open reading frame, and proteins whose size is not within a certain percentage of the expected size, for example, not within 10%, 20%, 25%, 30%, 40%, or 50% of the expected size of the protein can be rejected.

Arrays of the Invention

One convenient form of the invention is in an array format. Arrays (e.g., microarrays) are know in the art and may contain any variety or combination of variety of molecules. A number of formats of arrays are described in U.S. Pat. Nos. 5,545,531, 5,510,270, 5,807,522, 6,054,270, 6,566,495, and 6,824,866, the entire disclosures of which are incorporated herein by reference.

In some embodiments of the invention, the array may contain one or more antibodies on the solid support and may be used to identify antigens in the sample that bind to an antibody on the array. In other embodiments of the invention, the array may contain one or more antigens on the solid support and may be used to identify antibodies in the sample that bind to an antigen on the array.

Arrays of the invention may be formed on a flat surface (e.g., the surface of a glass microscope slide) or other type of surface (e.g., one or more beads). As an example, an array of the invention can be formed using the wells of a 96-well titer plate. In such an embodiment, each well is a “location” that is the functional equivalent of a “spot” of an array prepared on a flat surface.

The amount of material applied at each location of the array, the size of the location, the density of the locations in terms of square area, and the number of locations will vary with factors such as the size of the array, the intended use of the array, and the format of the array.

In many instances, the amount of fluid used to prepare each location of arrays of the invention will be within the range of from about 0.0001 nanoliters to about 5 microliters. Thus, the invention includes methods for making arrays and arrays that are prepared by the deposition or placement at each location of a volume of fluid in the ranges of from about 0.0001 nanoliters to about 10 microliters, from about 0.001 nanoliters to about 5 microliters, from about 0.01 nanoliters to about 5 microliters, from about 0.1 nanoliters to about 5 microliters, from about 1 nanoliters to about 5 microliters, from about 10 nanoliters to about 5 microliters, from about 100 nanoliters to about 10 microliters, from about 1 nanoliters to about 10 microliters, from about 1 nanoliters to about 5 microliters, from about 1 nanoliters to about 2 microliters, from about 1 nanoliters to about 1 microliters, from about 1 nanoliters to about 0.5 microliters, from about 1 nanoliters to about 0.1 microliters, from about 1 nanoliters to about 0.05 microliters, etc.

With respect to the density of locations of the array, these may vary considerably. For example, density will vary with factors such as, the number of locations, the size of the array, and the size of individual locations. Along these lines, the invention includes array that contain locations at densities of, for example, from about 1 to about 1,000 locations per cm², from about 5 to about 1,000 locations per cm², from about 10 to about 1,000 locations per cm², from about 20 to about 1,000 locations per cm², from about 40 to about 1,000 locations per cm², from about 60 to about 1,000 locations per cm², from about 400 to about 1,000 locations per cm², from about 200 to about 1,000 locations per cm², from about 100 to about 1,000 locations per cm², from about 200 to about 1,000 locations per cm², from about 300 to about 1,000 locations per cm², from about 400 to about 1,000 locations per cm², from about 500 to about 1,000 locations per cm², from about 650 to about 1,000 locations per cm², from about 10 to about 1,000 locations per cm², from about 10 to about 800 locations per cm², from about 10 to about 700 locations per cm², from about 10 to about 600 locations per cm², from about 10 to about 500 locations per cm², from about 10 to about 400 locations per cm², from about 10 to about 300 locations per cm², from about 110 to about 200 locations per cm², from about 110 to about 100 locations per cm², from about 10 to about 50 locations per cm², from about 0.5 to about 20 locations per cm², from about 0.25 to about 20 locations per cm², etc. For sake of clarity, when an array contains from about 500 to about 1,000 locations per cm² this does not mean that the array must contain at least 500 locations, as an example. If the area of the array being measured has an area of less than a square centimeter, then the array may contain fewer than 500 locations. Thus, number of locations per cm² refers to the number of locations in an area, not the number of locations on an array.

The total number of location of an array of the invention may vary greatly and may be from about two to about twenty thousand, from about five hundred to about twenty thousand, from about one thousand to about twenty thousand, from about five thousand to about twenty-thousand, from about two to about five thousand, from about two to about one thousand, from about two to about five hundred, from about two to about three hundred, from about fifty to about twenty thousand, from about fifty to about five thousand, from about fifty to about three thousand, from about one hundred to about twenty thousand, from about one hundred to about five thousand, from about one hundred to about three thousand, from about three hundred to about twenty thousand, from about three hundred to about five thousand, from about three hundred to about three thousand, from about four hundred to about eighth thousand, etc.

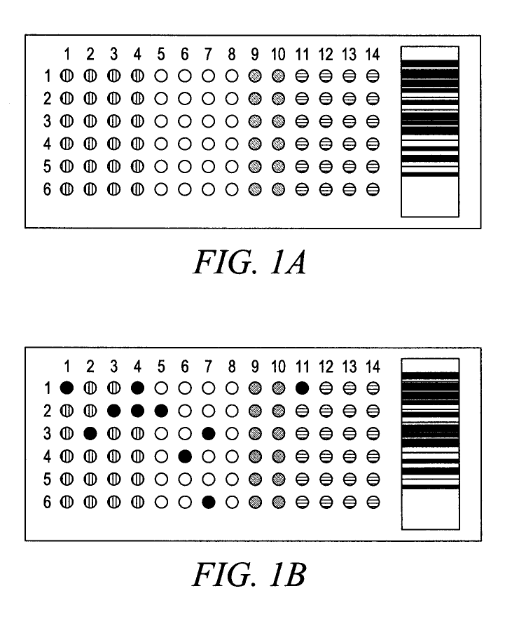

One embodiment of the invention is shown in FIG. 1A and FIG. 1B. These figures represent a microarray format of a composition of the invention and its use. In this embodiment, the microarray contains proteins with sequence homology and/or identity to proteins of pathogenic agents. In most instances, these proteins will share sufficient sequence identity or similarity with proteins of pathogenic agents so that antibodies generated in response to these proteins are capable of binding to proteins on the microarray.

As is seen in FIG. 1B, ten spots show clear positive reactions. The sample thus contains antibodies generated in response to six molecules produced by pathogens (Sections 1, 3, and 4) and antibodies to four molecules generated in response to vaccines (Section 2).

Array Production

Proteins (e.g., isolated proteins) can be placed on an array using a variety of methods known in the art. In one embodiment, proteins are printed onto a solid support. Both contact and non-contact printing can be used to spot the protein. In a specific embodiment, each protein is spotted onto the substrate using an OMNIGRID™ (GeneMachines, San Carlos, Calif.) and quill-type pins, for example available from Telechem (Sunnyvale, Calif.). In a further embodiment, proteins are attached to the solid support using an affinity tag. Use of an affinity tag different from that used to purify the proteins is often desirable, since further purification is achieved when building the protein array.

Accordingly, in a further embodiment, proteins are bound directly to a support (e.g., a solid support). In another further embodiment, the proteins are bound to a solid support via a linker. In a particular embodiment, proteins are attached to a solid support via a His tag. In another particular embodiment, the proteins are attached to a solid support via a 3-glycidooxypropyltrimethoxysilane (“GPTS”) linker. In a specific embodiment, the proteins are bound to a solid support via His tags (e.g., six consecutive histidine residues), wherein the solid support comprises a flat surface. In one embodiment, proteins are bound to the solid support via His tags, wherein the solid support comprises a nickel-coated glass slide. In a further embodiment, proteins are bound to the support via biotin tags, wherein the solid support comprises a streptavidin-coated glass slide. In a specific embodiment, proteins are biotinylated at a specific site in vivo. In a certain illustrative embodiment, the specific site on the protein that is biotinylated in vivo is a BIOEASE™ tag (Invitrogen Corporation).

The positionally addressable arrays of proteins of the present invention are not limited in their physical dimensions and can have any dimensions that are useful. In some embodiments, the positionally addressable array of proteins has an array format compatible with automation technologies, thereby allowing for rapid data analysis. Thus, in one embodiment, the positionally addressable array of proteins format is compatible with laboratory equipment and/or analytical software. In an illustrative embodiment, the positionally addressable array is a microarray of proteins and is the size of a standard microscope slide. In another embodiment, the positionally addressable array is a microarray of proteins designed to fit into a sample chamber of a mass spectrometer.

The present invention also relates to methods for making a positionally addressable array comprising the step of attaching to a surface of a solid support, at least 100, 200, 300, 400, 500, or 600 (e.g., 10 to 20,000, 10 to 7,000, 10 to 5,000, 10 to 2,000, 50 to 20,000, 50, to 7,000, 50, 2,000, etc.) proteins, with each protein being at a different position on the solid support, wherein the protein comprises a first tag. In certain aspects, one or more protein on the array comprises a second tag. The advantages of using double-tagged proteins include the ability to obtain highly purified proteins, as well as providing a streamlined manner of purifying proteins from cellular debris and attaching the proteins to a solid support. In a particular aspect, the first tag is a glutathione-S-transferase tag (“GST tag”) and the second tag is a poly-histidine tag (“His tag”).

Protein microarrays used in methods provided herein can be produced by attaching a plurality of proteins to a surface of a solid support, with each protein being at a different position on the solid support, wherein the protein comprises at least one tag. The advantages of using double-tagged proteins include the ability to obtain highly purified proteins, as well as providing a streamlined manner of purifying proteins from cellular debris and attaching the proteins to a solid support. The tag can be for example, a GST tag, a His tag, or a biotin tag. The biotin tag can be associated with a protein in vivo or in vitro. Where in vivo biotinylation is used, a peptide for directing in vivo biotinylation can be fused to a protein. For example, a BIOEASE™ tag can be used. In certain aspects, a biotin tag is used for protein immobilization on a protein microarray substrate and/or to isolate a recombinant fusion protein before it is immobilized on a substrate at a positionally addressable location. In a particular embodiment, the first tag may be a GST tag and the second tag may be a His tag. In a further embodiment, the GST tag and the His tag may be attached to the amino-terminal end of the protein. Alternatively, the GST tag and the His tag may be attached to the carboxy-terminal end of the protein.

Interaction Detection

Any number of detection methods may be used in the practice of the invention. For example, a detectably labeled second antibody may be used to identify binding of a first antibody to a composition of the invention. For example, when the sample is from a human individual, the presence of a human first antibody at a location on an array may be detected by a labeled second antibody with binding affinity for the first antibody (e.g., a detectably labeled anti-human antibody). Labeling and detection methods are described, for example, in U.S. Patent Application Publication No. 2003/0092074, the entire disclosure of which is incorporated herein by reference.

Detectably labeled molecules used in the practice of the invention may be labeled in any number of ways. Examples of labeling methods that may be used include the following: gold (silver) labeling methods, fluorescence labeling methods, chemiluminescence labeling methods, electrochemiluminescence labeling methods, and radioactive labeling method or magnetic labeling methods. Different label reagents can be used together. For example, different fluorescence reagents with different wavelength may be bound to different second antibodies. This may be useful if one wishes to distinguish between IgG and IgM classes of first antibodies. Thus, the invention provides methods for measuring induction of immune responses. Typically, IgM class antibodies are produced first, followed by the production of IgG class antibodies. Second antibodies specific for these classes, as an example, can be employed to measure where the individual is in the immune response “cycle”. Similarly, second antibodies may be used to distinguish antibody subclasses (e.g., IgG, subclass 1; IgG, subclass 2; IgG, subclass 3; and IgG, subclass 4).

Numerous labels are available that can be generally grouped into the following categories: (a) Radioisotopes, such as ³⁵S, ¹⁴C, ¹²⁵I, ³H, and ¹³¹I. The antibody can be labeled with the radioisotope using the techniques described in Current Protocols in Immunology, Volumes 1 and 2 (Coligen, et al., Eds. Wiley-Interscience, New York, N.Y., 1991). (b) Colloidal gold particles. (c) Fluorescent labels including, but are not limited to, rare earth chelates (europium chelates), Texas Red, rhodamine, fluorescein, dansyl, Lissamine, umbelliferone, phycocrytherin, phycocyanin, or commercially available fluorophores such SPECTRUM ORANGE™ and SPECTRUM GREEN™ and/or derivatives of any one or more of the above. The fluorescent labels can be conjugated to the antibody using the techniques disclosed in Current Protocols in Immunology, supra, for example. Fluorescence can be quantified using a fluorimeter. (d) Various enzyme-substrate labels are available and U.S. Pat. No. 4,275,149 provides a review of some of these. The enzyme generally catalyzes a chemical alteration of the chromogenic substrate that can be measured using various techniques. For example, the enzyme may catalyze a color change in a substrate, which can be measured spectrophotometrically. Alternatively, the enzyme may alter the fluorescence or chemiluminescence of the substrate. Techniques for quantifying a change in fluorescence are described above. The chemiluminescent substrate becomes electronically excited by a chemical reaction and may then emit light that can be measured (using a chemiluminometer, for example) or donates energy to a fluorescent acceptor. Examples of enzymatic labels include luciferases (e.g., firefly luciferase and bacterial luciferase; U.S. Pat. No. 4,737,456), luciferin, 2,3-dihydrophthalazinediones, malate dehydrogenase, urease, peroxidase such as horseradish peroxidase (HRPO), alkaline phosphatase, β-galactosidase, glucoamylase, lysozyme, saccharide oxidases (e.g., glucose oxidase, galactose oxidase, and glucose-6-phosphate dehydrogenase), heterocyclic oxidases (such as uricase and xanthine oxidase), lactoperoxidase, microperoxidase, and the like. Techniques for conjugating enzymes to antibodies are described in O'Sullivan, et al., Meth. Enzymol. 73:147-166, 1981.

Examples of enzyme-substrate combinations include, for example: (i) Horseradish peroxidase (HRPO) with hydrogen peroxidase as a substrate, wherein the hydrogen peroxidase oxidizes a dye precursor (e.g., orthophenylene diamine (OPD) or 3,3′,5,5′-tetramethyl benzidine hydrochloride (TMB)); (ii) alkaline phosphatase (AP) with para-Nitrophenyl phosphate as chromogenic substrate; and (iii) β-D-galactosidase (β-D-Gal) with a chromogenic substrate (e.g., p-nitrophenyl-β-D-galactosidase) or fluorogenic substrate (e.g., 4-methylumbelliferyl-β-D-galactosidase).

Numerous other enzyme-substrate combinations are available to those skilled in the art. For a general review of these, see U.S. Pat. Nos. 4,275,149 and 4,318,980. Sometimes, the label is indirectly conjugated with the antibody. The skilled artisan will be aware of various techniques for achieving this. For example, the antibody can be conjugated with biotin and any of the four broad categories of labels mentioned above can be conjugated with avidin, or vice versa. Biotin binds selectively to avidin and thus, the label can be conjugated with the antibody in this indirect manner. Alternatively, to achieve indirect conjugation of the label with the antibody, the antibody is conjugated with a small hapten and one of the different types of labels mentioned above is conjugated with an anti-hapten antibody. Thus, indirect conjugation of the label with the antibody can be achieved.

Other types of labels that may be used in the practice of the invention include QDOTS® (Invitrogen Corporation). Qdot products combine fluorescence performance inherent in the nanocrystal structure with a highly customizable surface for directing the bioactivity of Qdot nanocrystals or for conjugating them to a wide range of molecules of interest. Advantages of QDOT® include (1) long-term photostability, (2) fixability for follow-up immunofluorescence, (3) archivability for permanent sample storage in pathology, and (4) brilliant colors for simple, single-excitation source, multicolor analysis.

Fundamentally, Qdot nanocrystals are fluorophores-substances that absorb photons of light, then re-emit photons at a different wavelength. However, QDOTS® exhibit some important differences as compared to traditional fluorophores such as organic fluorescent dyes and naturally fluorescent proteins. Qdot nanocrystals are nanometer-scale (roughly protein-sized) atom clusters, containing from a few hundred to a few thousand atoms of a semiconductor material (cadmium mixed with selenium or tellurium), which has been coated with an additional semiconductor shell (zinc sulfide) to improve the optical properties of the material. These particles fluoresce in a different way than do traditional fluorophores, without the involvement of π->-π* electronic transitions. Thus, the invention includes the use of labels that comprise fluorescent nanoparticles and fluorescent-magnetic nanoparticles, as well as other nanoparticles. Such particles are described in U.S. Pat. Nos. 6,444,143, 6,530,944, 6,734,420, 6,838,243, and 7,235,228, the entire disclosures of which are incorporated herein by reference.

Fluorescent dyes suitable for use with the invention include, but are not limited to, fluorescein and fluorescein dyes (e.g., fluorescein isothiocyanine or FITC, naphthofluorescein, 4′,5′-dichloro-2′,7′-dimethoxy-fluorescein, 6-carboxyfluorescein or FAM), carbocyanine, merocyanine, styryl dyes, oxonol dyes, phycoerythrin, erythrosin, eosin, rhodamine dyes (e.g., carboxytetramethylrhodamine or TAMRA, carboxyrhodamine 6G, carboxy-X-rhodamine (ROX), lissamine rhodamine B, rhodamine 6G, rhodamine Green, rhodamine Red, tetramethylrhodamine or TMR), coumarin and coumarin dyes (e.g., methoxycoumarin, dialkylaminocoumarin, hydroxycoumarin and aminomethylcoumarin or AMCA), Oregon Green Dyes (e.g., Oregon Green 488, Oregon Green 500, Oregon Green 514), Texas Red, Texas Red-X, SPECTRUM RED™, SPECTRUM GREEN™, cyanine dyes (e.g., Cy-3™, Cy-5™, Cy-3.5™, Cy-5.5), ALEXA FLUOR® dyes (e.g., ALEXA FLUOR® 350, ALEXA FLUOR® 488, ALEXA FLUOR® 532, ALEXA FLUOR® 546, ALEXA FLUOR® 568, ALEXA FLUOR® 594, ALEXA FLUOR® 633, ALEXA FLUOR® 660 and ALEXA FLUOR® 680), BODIPY® dyes (e.g., BODIPY® FL, BODIPY® R6G, BODIPY® TMR, BODIPY® TR, BODIPY® 530/550, BODIPY® 558/568, BODIPY® 564/570, BODIPY® 576/589, BODIPY® 581/591, BODIPY® 630/650, BODIPY® 650/665), IRDye® (e.g., IRDye® 40, IRDye® 700, IRDye® 800), and the like. For more examples of suitable fluorescent dyes and methods for coupling fluorescent dyes to other chemical entities see, for example, “The Handbook of Fluorescent Probes and Research Products”, 9th Edition, Molecular Probes, Incorporated, Eugene, Oreg. (a part of Invitrogen Corporation).

Vaccine Development

There are a number of potential vaccines under development. Quickly understanding the quantity and quality of the protective response these vaccines generate is a priority. Vaccine development is relatively slow, and any improvement to this timeline is of great importance. One of the most difficult tasks in developing a recombinant protein subunit vaccine or DNA vaccine or when selecting an antigen or set of antigens to use for diagnostic and/or immune status monitoring purposes is the identification of the antigens that will stimulate the most effective immune response against the pathogen, particularly when the genome of the organism is large. For example, it is not practical for bacteria like Bacillus anthracis, which encode thousands of antigens, to test these antigens one at a time. It is also impractical to screen multiple potential virusal vaccines or component viral proteins simultaneously. Thus, the invention includes methods for assess the quality of vaccines. In some instances, such assessments may involve administering vaccines to one or more individuals followed by the testing of samples (e.g., blood samples) for the presence of antibodies generated in response to the vaccine. For example, samples could be obtained from one or more individuals at timed intervals (e.g., every three, four, five, six, seven, eight, nine, ten, twelve, etc. days), followed by testing of the samples for antibodies generated in response to the vaccine. Such assessments also allow for the identification of vaccine constituents that induce immune responses more rapidly than other vaccine constituents.

Protein microarrays have been used to screen hundreds of proteins simultaneously for reactivity with serum antibodies in autoimmune disease, cancer, and infection. The invention includes, in part, the characterization of immune responses to many pathogens and emerging pathogenic agents using compositions of the invention (e.g., microarrays of large numbers of purified proteins from these pathogens). For example, the invention includes methods involving contacting an individual, or group of individuals, with pathogen molecules, followed by screening the individual for an immunological response to specific molecules. The individual may be contacted with pathogen molecules in any number of ways. For example, the individual may be contacted with an essentially “complete” collection of molecules of an inactivated pathogen (e.g., a pathogen that has been rendered non-viable by exposures to heat or irradiation). Also, the individual may be contacted with a mixture of pathogen molecules prepared by combining the molecules.

No fully accepted and approved vaccines are available for many pathogens. Examples include dengue, Marburg or Ebola. However, there are a number of very promising potential vaccines under development. Quickly understanding the quantity and quality of protective response these vaccines generate is a high research priority. Vaccine development is relatively slow, and any improvement to this timeline is of great importance. Microarrays hold great promise of dramatically increasing the quantity and quality of data obtained from studies to uncover the host's antibody response to a vaccine. Since animal studies, and phase 1-3 trials are costly and time consuming, rapid generation of large amounts of microarray data relating to the vaccine's immunogenicity, or any potentially harmful complication, may decrease vaccine development time and increase safety. With multiple new vaccines under development, the ability of microarrays to quickly provide comparative data from different vaccines could be very important. Microarrays thus hold promise of dramatically increasing the quantity and quality of data obtained from studies to uncover the host's antibody response to a vaccine.

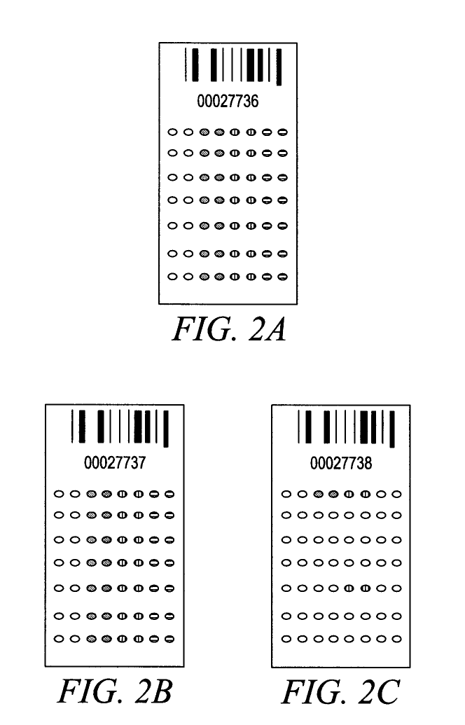

In one aspect, the invention includes methods of developing new vaccines based upon immune responses induced by prior vaccines. One example of such methods is described in FIG. 2. In FIG. 2A data is shown that represent immune responses induced by a prior smallpox vaccine. These data are compared to those derived from use of new smallpox vaccine candidates (FIG. 2B and FIG. 2C) to assess whether the new vaccine candidate is capable of inducing protective immune responses (FIG. 2B) or whether the new vaccine candidate is unlikely to fully protect (FIG. 2C).

Vaccinology

In some compositions of the invention, arrays (e.g., microarrays, such as protein microarrays) may contain defined sets of proteins arrayed in up to 20,000 nano-dots on microscope-sized array. The unique advantage of protein arrays is the ability, in a single experiment, to rapidly and simultaneously evaluate very large numbers of proteins for antigenicity and immunogenicity, biochemical activities, or protein protein interactions.

An array to detect immune status of an individual (e.g., a soldier, civilian, immigrating person, etc.) could contain, in an appropriately folded fashion, the majority of proteins or other pathogen molecules from different vaccines. Testing an individual's serum on such antigen-containing microarrays can dramatically increase the quantity and quality of data obtained from studies of an individual or animals protective antibody status. In two to three hours, a blood sample can be tested on the arrays to uncover the individual's complete immune history, and establish the individual's current protective status and need for booster immunizations. A very small blood sample, representing just microliters of blood, is all that's needed for testing. Thus, the invention includes methods for identifying immune status of an individual that employs a small samples size (e.g., from about two microliters to about one milliliter, from about five microliters to about one milliliter, from about ten microliters to about one milliliter, from about twenty microliters to about one milliliter, from about fifty microliters to about one milliliter, from about one hundred microliters to about one milliliter, from about two hundred microliters to about one milliliter, from about four hundred microliters to about one milliliter, from about two microliters to about eight hundred microliters, from about two microliters to about five hundred microliters, from about two microliters to about three hundred microliters, from about two microliters to about two hundred microliters, from about twenty microliters to about eight hundred microliters, from about thirty microliters to about five hundred microliters, from about fifty microliters to about five hundred microliters, from about one hundred microliters to about five hundred microliters, from about four hundred microliters to about eight hundred microliters, etc.).

Such arrays represent a significant tool to help in the management of immunization programs. Such arrays allow considerable flexibility for the military and civilians to create immunization management programs within current medical practices. For example, since less than a drop of blood is needed for testing, the invention allows for a program of testing a person or animals immune status using a system of “mailed samples” available from filter paper blood spots obtained by finger-stick.

The use of filter paper (e.g., Whatman 3MM filter paper) provides an inexpensive method for the collection, shipment, and storage of samples. This is especially the case when samples are collected in remote areas where there is no access to refrigeration. Thus, in some aspects, the invention includes the use of samples on filter paper.

One example of a filter paper based medium used for the collection, shipment, and storage of blood samples is FTA® paper, which is composed of cellulose material impregnated with (i) a monovalent weak base; (ii) a chelating agent; (iii) an anionic detergent; and, optionally, (iv) uric acid or a urate salt. FTA® paper can be used to store human genomic DNA, for example, in the form of dried spots of whole blood, the cells of which lyse after making contact with the paper. Stored at room temperature, genomic DNA on FTA®. Paper, for example, is reported to be stable for at least 7.5 years (Burgoyne, et al., Conventional DNA Collection And Processing: Disposable Toothbrushes And FTA® Paper As A Non-Threating Buccal-Cell Collection Kit Compatible With Automatable DNA Processing, 8th International Symposium on Human Identification, Sep. 17-20, 1997). Thus, the placement of samples on filter paper (e.g., FTA® paper) offers a compact archival system compared to glass vials or plastic tubes located in precious freezer space and may be used in the practice of the invention.

The storage of blood samples on dried filter paper has the additional advantage of pathogen inactivation. More specifically, HIV, as well as a number of other infectious agents, is believed to lose viability upon drying. Thus, the invention includes the use of blood samples that have been stored as described above.

Automation of testing allows for high throughput of samples obtained during routinely scheduled medical appointments. Because of the large number of tests that can be performed on each assay simultaneously, cost per assay is minimized. Assays such as those described herein will yield considerable quantitative and qualitative data on the magnitude and breadth of the individual's immune status. These data lend themselves to high speed computer analysis and storage, and the image of the array can be included in a paper-less medical record. Indeed, arrays themselves can be archived for re-evaluation and as such, they would contain an individual's permanent “immune-history”. This record would show not only the individual's immune protection level induced by vaccines, but also immunity resulting from natural infections encountered throughout the individual's life. The record is useful for future documentation of currently-undefined diseases or syndromes.

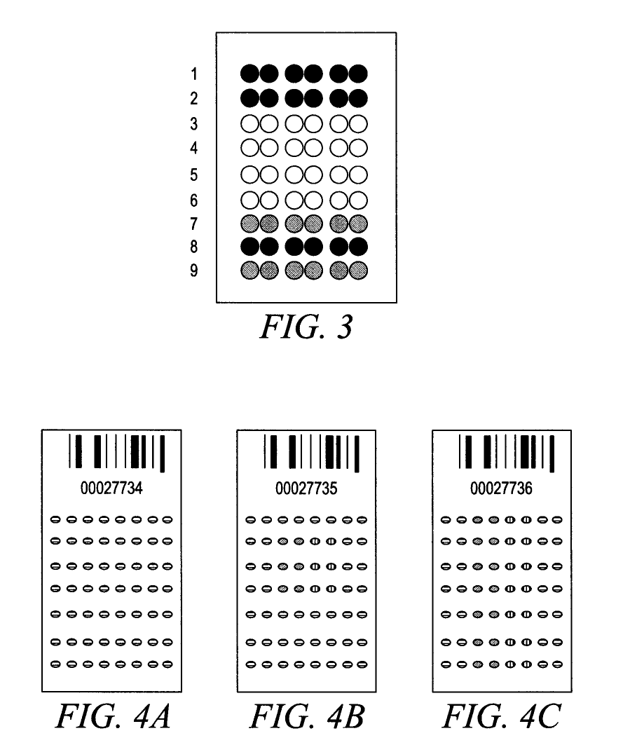

In regard to the military, immune status arrays can be military-need specific. Such an array can be viewed as a “Warfighter's Array” containing, for example, the majority of proteins, or other molecules, from different vaccines utilized by the military. The military immunizes against a number of pathogens, including vaccinia, anthrax, VEE, YF, JS, TBE, influenza, adenovirus, rabies, childhood immunizations (measles, mumps, rubella, polio, etc.), DPT, hepatitis B, hepatitis A, varicella (chicken pox), and cholera, and often the Warfighter needs a booster. With limited vaccine supplies available, when vaccine has an elevated prevalence of side effects, or when a vaccine poses a potential litigation exposure, it is desirable to reduce immunization or booster immunization to only those that vitally need the vaccine. Testing an individual's serum on these arrays will dramatically increase the quantity and quality of data obtained from studies of a Warfighter's protective antibody response to vaccination. In 2-3 hours, perhaps prior to deployment, a Warfighter's blood can be tested on arrays to uncover the individual's complete immune history, and establish current protective status and the need for booster immunizations. Such an array could also be useful for vaccinating lab workers and researchers. Arrays rapidly demonstrate an “antibody fingerprint” that gives antibody titer information (IgG, IgM, IgA) on multiple infectious agents, or on each pathogen's individual proteins (FIG. 3). In this hypothetical example, the individual reacts strongly to influenza A, influenza B, and polio, weakly to rubella and mumps, and does not react to tularemia, SARS, avian flu, and dengue. This cost-effective tool will help the military manage force immunization readiness programs, and ensure force availability for essential missions.

Development of Antimicrobials

Unfortunately, particularly for many difficult-to-treat diseases, there are relatively few antimicrobials. Examples would include dengue, since to date, limited antiviral drug chemotherapy studies have not proved successful; consequently, most currently used forms of therapy for uncomplicated dengue are supportive in nature. Also for Ebola/Marburg, few laboratories possess the safety facilities necessary for extensive therapeutic animal model research. Microarray studies, combined with clinical or animal models samples, can assist in advances in our basic understanding of the virulence of infectious agents. The arrays may be used to uncover protein-protein and other pathogen-host interactions. Preventing or disrupting such interactions typically represents a good strategy for expanded applied research aimed at the development of new antimicrobials.

Microarrays for allow the development of new experimental approaches to uncover protein-protein interactions and immune responses during the infectious cycle. Knowledge from such studies can lead to advances in our basic understanding of the virulence of the pathogen, and expand applied research aimed at the development of antimicrobials and preventative vaccines. Furthermore, where a putative antimicrobial exists, often the mechanism of action is difficult to uncover. Using arrays to analyze an animal's infection with or without an antimicrobial, can yield information on how the animal processed the infection while being treated. In addition, probing protein microarrays with small molecules has been shown to give direct information about mechanism of action (Huang, et al., 2004). Thus, the invention includes methods for studying pathogen-host interactions, as well as pathogen-drug interactions.

### Infection and Organism Virulence and Pathogenicity Studies

For many pathogens, an understanding of their replication and pathogenicity has been limited by few carefully examined human cases or the lack of sufficient animal models that mimic human disease. Thus, our knowledge of virulence factors, and our understanding of a host's protective response, is very limited. Arrays are valuable for exploring the infectious process in humans and animals. Arrays allow researchers to expand the amount of information they can currently obtain from analyzing the host's response to the infecting agent. They generate a significant increase of new information from each sample, and thus would greatly expand the usefulness of the limited animal models available for many diseases. Thus, the invention includes methods involving the collection of data from numerous individuals (e.g., individuals exposed to a pathogen) and the analysis of those data to characterize responses (e.g., immunological responses) of the individuals.

For example, although viral agents are much smaller than bacterial pathogens, often their parasitic, intracellular nature poses considerable complexities to understanding their infection in individuals. For many viruses, there are still significant gaps in our knowledge in critical areas important for control and prevention of disease. This complexity of replication patterns in hosts, along with difficulties establishing virulence factors and protective host responses, makes the development of new therapeutics and new vaccines particularly challenging. The significant increase of information that can be generated from studies utilizing protein arrays should facilitate new types of experiments and research approaches to further scientist's knowledge about viral diseases. For some diseases, especially those that are new or re-emerging, the need for more information on the infectious process is a pressing issue among researchers.

Examples of this are the limited animal models for dengue and Ebola/Marburg. Interestingly, these two groups of viruses pose separate, extremely complex human infection cycles. For Ebola/Marburg, the extent and severity of pathogenicity and resulting mortality is exceptional. Unlike most other viruses, these viruses appear to replicate and damage a wide range of tissues and organs. The extreme severity of these infections probably indicates that multiple different pathogenicity events are occurring. Most likely, these viruses have unique, yet currently unidentified, methods for evading or controlling the body's attempts to throttle-down the infection. Knowledge about this pathogenicity might yield valuable new understanding of the body's complicated response to any infection. For example, Ebola/Marburg viral molecules that perhaps control the body's inflammation response (to allow the virus to replicate), might eventually lead to new medicines useful as a therapeutic agents for chronic inflammatory diseases. For dengue, there are four closely related, but serologically distinct, dengue viruses (types 1 through 4). Because there is no cross-protection between the four types, a population could experience a dengue-1 epidemic in 1 year, followed by a dengue-2 epidemic the next year. Primary infection with any serotype often causes a debilitating, but usually nonfatal, form of illness. However, some infected individuals experience a much more severe, and often fatal, form of the disease, called dengue hemorrhagic fever (DHF), the most severe form of which is referred to as dengue shock syndrome (DSS). Unlike other infectious diseases, the presence of antibodies after recovery from one type of dengue infection is believed, under certain incompletely understood circumstances, to predispose some individuals to the more severe form of disease (DHF/DSS) through immune-enhancement when infected by a different dengue virus serotype.

Although all age groups are susceptible to dengue fever, DHF is most common in children. This unique form of pathogenicity is still poorly understood, but appears to occur, to a much less extent, with other viral infections. Thus, better pathogenicity studies on dengue would represent a useful model for other viral diseases.

It is further envisioned that arrays will be particularly valuable for research exploring the infectious process in the human host and in animal models. Arrays hold the potential to gather a significant increase of new information from each sample, and thus would greatly expand the usefulness of the limited animal models available for many viral diseases. For high containment diseases, because of the severe disease produced by these pathogens and the high potential hazard incurred during laboratory manipulation of them, progress in understanding both the agent's biology and epidemiology has been limited. Few laboratories in the world possess the safety facilities necessary for making specific diagnosis of infection, much less the resources required for intensive research. For these diseases, animal studies are very costly in BSL-4 facilities, and valuable primates are often sacrificed. Using arrays to obtain the maximum information from each sample is of considerable importance. Thus, the invention includes methods for obtaining numerous data point from a sample. One example of a data point is the presence of an antibody that binds to a single protein or domain of a protein of a pathogen. Thus, if an array contains a full-length protein of a pathogen and a domain of the same protein and the samples contains antibodies that bind to each, then two data points are said to have been obtained. Any number of data points may be obtained by methods of the invention, including from about two to about twenty thousand, from about five to about twenty thousand, from about ten to about twenty thousand, from about twenty to about twenty thousand, from about thirty to about twenty thousand, from about forty to about twenty thousand, from about fifty to about twenty thousand, from about one hundred to about twenty thousand, from about two hundred to about twenty thousand, from about five hundred to about twenty thousand, from about two to about four thousand, from about ten to about four thousand, from about twenty to about four thousand, from about fifty to about four thousand, from about one hundred to about four thousand, from about two hundred to about four thousand, from about fifty to about one thousand, from about one hundred to about one thousand, etc.

Further, the number of data points may be an average for the samples tested, +/−less than 2%, 5%, 10%, 15%, or 20%. For example, if five samples are tested with the possibility of generating one thousand (e.g., there are 1,000 location on an array that is used), and the number of locations that are positive for each sample are 35, 37, 42, 45, and 51, then the average number of data points is 42.

Diagnosis

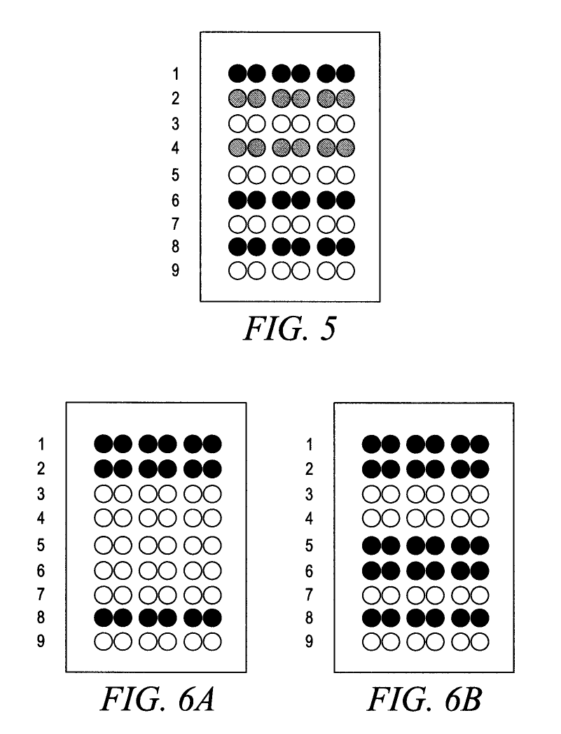

Microarrays can replace currently used diagnostic assays that often provide limited information. For example, microarrays might replace currently used diagnostic assays that often provide limited information. During the convalescent period after infection, microarrays dramatically increase the quantity and quality of data obtained from studies to uncover the host's antibody response to the infecting agent or a vaccine. Using only a patient's convalescent sera, microarrays hold the potential of identifying the infecting virus down to the strain or substrain level. This can be particularly important for new or newly emerging diseases and for “fine tuning” the identification of pathogens. These problems are particularly acute with many viral infections. For example, diagnosis is often hard for those viruses causing hemorrhagic disease such as Ebola and Marburg, or dengue. Also, for many of zoonotic and arthropod-borne viruses, each virus usually has multiple strains, and often multiple related but distinct viruses. Although a limited number of strains exist for Marburg and Ebola viruses, there are over 600 arthropod-borne viruses alone, and diagnosing such closely related viruses as dengue (types 1-4), West Nile, St. Louis encephalitis, Japanese encephalitis, and yellow fever, is often extremely difficult. If the virus itself can be isolated from the patient, identification and definitive diagnosis is straightforward. However, for many of these diseases, isolation of the virus is not likely, and diagnosis must be performed using serological tests of the patient's humoral antibody response. Thus, the invention includes methods for identifying pathogens, as well as strains and substrains of pathogens, using compositions of the invention. In some embodiments of the invention, arrays are used that contain molecules that are specific for a pathogen, a particular strain of the pathogen, and/or a particular substrain of the pathogen. For example, an array of the invention may contain proteins (e.g., proteins known to elicit an immunological response from individuals), or portions thereof, in separate locations. These proteins may fall into two categories: (1) proteins common to all members of the pathogen group and (2) proteins that are specific for particular strains or substrains (FIG. 5). In this example, the individual is diagnosed with dengue type 1 (row 1), as opposed to dengue type 2 (row 2), dengue type 3 (row 3), or dengue type 4 (row 4). In a specific example, a portion of corresponding to (e.g., identical to) a conserved region of a pathogen protein and known to bind antibodies generated in response to that pathogen protein may be at a first location. A portion of a region of another pathogen protein corresponding to the amino acid sequence of a less conserved protein and known to bind antibodies generated in response to that pathogen protein may be at a second location. A positive result at the first location but not the second location suggests/indicates that the individual has been exposed the pathogen but not the strain of the pathogen containing the protein represented at the second location. Methods or the invention may be used to identify pathogens and any number of strains or substrains of that pathogen (e.g., from about two to about one hundred, from about four to about one hundred, from about five to about one hundred, from about ten to about one hundred, from about fifteen to about one hundred, from about twenty to about one hundred, from about two to about fifty, etc. strains and/or substrains).

Another use of arrays of the invention is for very-early, pre-symptomatic diagnosis where the microarray may detect early changes in the body as the host starts its fight against the pathogen (FIG. 4A. FIG. 4B, and FIG. 4C). FIG. 4A represents the array profile of a healthy individual, FIG. 4B represents the array profile of a pre-symptomatic infected individual, and FIG. 4C represents the array profile of an individual with early-stage disease. These changes could be early, innate or general protein responses, or early specific immunological responses.

Research on Disease Surveillance

Surveillance for diseases often relies on isolating the virus during the outbreak, or evaluating the spread of the virus by analyzing sera from infected hosts. The filoviruses (Ebola and Marburg) represent good examples of viruses where microarrays are tools for uncovering the natural history of the disease. Our knowledge of these viruses is derived largely from a limited number of dramatic epidemics plus sporadic cases. Because of the severe disease produced by these viruses and the high potential hazard incurred during laboratory manipulation of them, progress in developing tools to aid our understanding of their epidemiology has been limited. Thus, current information is inadequate to indicate the prevalence and incidence of Marburg and Ebola virus infections in the general population in endemic areas. Furthermore, the true origin and the natural cycle of maintenance for Marburg and Ebola viruses remain unsolved. Arrays, with their potential ability to determine the infecting virus by analyzing the convalescing host's antibody response, hold great promise as a new tool to uncover the emergence and spread of disease. Arrays can also be used with various host species to uncover the natural cycle of viruses in their environment.

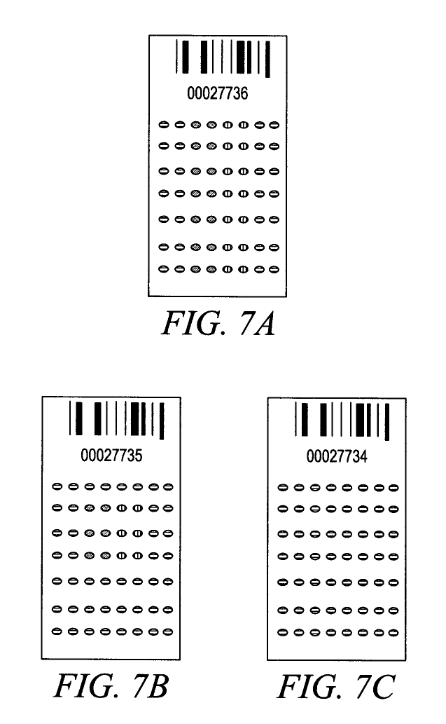

Surveillance for disease outbreaks is often performed by testing for antibodies to determine if the disease has infected a group of susceptible hosts. However, if some hosts are immunized, they will also show antibodies and disease tracking is limited. Arrays rapidly demonstrate an “antibody fingerprint” that can separate naturally infected animals (FIG. 7A), immunized animals (FIG. 7B), and animals neither immunized nor infected (FIG. 7C). Thus arrays could represent valuable new technology for such zooniotic diseases where an animal vaccine might be in use, such as foot and mouth disease, West Nile, Rift Valley fever, and Venezuelan equine encephalitis. Thus, the invention includes, in part, methods for distinguishing between antibodies associated with infections (FIG. 6B) and immunizations (FIG. 6A).

### Example 1

### Production and Validation of Proteome Microarrays

One of the most difficult tasks in developing a recombinant protein subunit vaccine or DNA vaccine, or when selecting an antigen or set of antigens to use for diagnostic and/or immune status monitoring purposes, is the identification of the antigens that will stimulate the most effective immune response against the pathogen, particularly when the genome of the organism is large. It is not practical for large viruses or bacteria, which encode hundreds or thousands of antigens, to test these antigens one at a time. Recently, however, protein microarrays have been used to screen hundreds of proteins simultaneously for assessment of their relative reactivity with serum antibodies elicited in autoimmune diseases, cancer, and subsequent to infection. To date, however, immune response to agents such as smallpox, hemorrhagic fever viruses, tularemia, anthrax, and plague have not been characterized using microarrays of large numbers of purified proteins from these pathogens.

The present example details the generation and validation of a unique set of reagents, including high quality clones and purified proteins, for an extended majority of the proteomes of poxviruses Vaccinia and Monkeypox strains Zaire and Sierra Leone, bacteria Yersinia pestis (var. KIM) and Bacillus anthracis (var. Ames), and proteome-scale microarrays for each. In addition, arrays with majority coverage of Francisella tularensis, and selected proteins from the hemorrhagic fever viruses Dengue (types 1-4), Ebola (str. Reston and Zaire), and Marburg (str. Musoke), and influenza viruses A and B, are also produced. These reagents are used to show that protein microarrays can be used as a diagnostic platform to characterize immunogenic protein determinants and protein interactions, profile antibody specificity, and measure immune response for these pathogens.

The present example details the characterization of mammalian immune responses to pathogens by translating proteins from pathogen genes (the “patheome”) and creating microarrays with these proteins. Development of these types of arrays, also known as immunoarrays, allows the determination of whether an immune response has been elicited due to vaccination and/or infection. In the case of vaccination, this will assist in development of new vaccines, determine if an individual has a modicum of protection, and establish a method to measure population resistance/susceptibility. In the case of infection, this product may also be useful as a diagnostic tool.

Yersinia pestis (var. KIM)

A total of 3968 Y. pestis GATEWAY™ Entry open reading frame (ORF) clones were obtained from the collection constructed at The Institute for Genomic Research (“TIGR”). Entry clones were sub-cloned into the pEXP1-GST expression vector via standard GATEWAY™ recombination (Invitrogen Corporation). The GATEWAY™ LR sub-cloning begins by growing entry clones in 2 ml deep-well plates (1 ml LB media with kanamycin) and then isolating the plasmid DNA using the PURELINK™ HQ kit (Invitrogen Corporation, centrifuge protocol). The purified entry plasmid DNA was recombined into the destination vector using a 5 μl scale LR reaction. The LR product mix was used to transform chemically competent DH10B cells. Afterwards, each transformation well was plated onto a Petri dish with media supplemented with ampicillin (Ap) and carbenicillin (Cb) antibiotics. For each transformation event, four colonies were robotically picked into a 384-well plate with LB-Ap/Cb media. Size validation of destination clones were performed by PCR amplification on overnight-grown colonies and sized on a CALIPERS AMS-90™ DNA chip (Caliper Life Sciences Corporation, Hopkins, Mass.). One of four destination colonies that matched the expected insert size was selected and re-arrayed into deep-well plates with 2xYT/antibiotics media.

Plasmid DNA was purified from 1.1 ml cultures of over-night destination clones grown in 2×YT media using a PERFECTPREP® Plasmid 96 Spin, Direct Bind kit (Eppendorf North America, Westbury, N.Y.). Final DNA elution was performed with two successive volumes that were combined after each spin through the binding plate. Entire 96-well plates of purified destination plasmid were evaluated for DNA concentration using the QUANT-IT™ Broad Range Kit (Invitrogen Corporation). Concentrations were determined from 5 μL aliquots of plasmid DNA and were performed as described in the product manual. After determining DNA concentration, a spot check for DNA quality was performed by running at least 16 samples from the assay plate (per plate) on a low resolution agarose gel using the E-GEL® 96 system (Invitrogen Corporation). Newly produced destination clones were also evaluated for correct gene identity by performing a single sequencing read on purified plasmid.

In the course of this work, it was found that in vitro expression of Y. pestis proteins using EXPRESSWAY™ products (Invitrogen Corporation) gave higher throughput and better yields of recombinant protein than intact E. coli cells. The EXPRESSWAY™ Cell-Free Expression System allows the direct synthesis of high yields of recombinant protein in a single reaction tube in just a few hours, eliminating the time-consuming steps of cell-based protein production such as transformation, cell culture maintenance, and expression optimization. This is accomplished with specially prepared E. coli extracts that provide the cellular machinery required to drive strong transcription and translation, in vitro protein synthesis reaction buffers to provide an energy regenerating system, and a T7 enzyme mix for an optimal transcription reaction.

A stock solution of 85 μl of EXPRESSWAY™ reaction mix (Invitrogen Corporation) composed of E. coli extract, reaction buffer, amino acids and T7 RNA polymerase enzyme mix was prepared and dispensed into each well of a deep well 96-well plate. A minimum of 500 ng purified plasmid DNA at 25-200 ng/μl was then robotically dispensed into each of 92 wells. Two wells received an expression-verified positive control expression plasmid pEXP-GST-CALML3. The plate was sealed and placed into a shaking incubator set to 30° C., 300 rpm, for one hour. The deep well plate was then removed from the incubator and centrifuged briefly at 1000-2000 rpm to collect contents into wells from well walls and the seal. One hundred μl of EXPRESSWAY™ Feed Buffer was then dispensed into each well using automated liquid handling equipment. The deep well plate was returned to the 30° C. shaking incubator for 3 hours.

Following centrifugation at 4000 rpm for 5 minutes, the supernatant was transferred to a fresh deep well plate using automated liquid handling equipment. A 50% slurry of wash buffer-equilibrated, glutathione-sepharose was added to the supernatant in each well, and the plate was placed at 4° C. in a shaking incubator set to 200 rpm. The well contents were then transferred to a 96-well filter plate, and the plate was centrifuged 1 minute at 3000 rpm. The resin was retained and washed 3 times in a HEPES buffer containing 1 M NaCl, followed by two washes in a HEPES buffer containing 200 mM NaCl. Bound protein was eluted using a buffer containing 20 mM reduced glutathione during an overnight incubation at 4° C. followed by centrifugation at 4000 rpm for 10 minutes. Supernatants containing eluted protein were transferred to fresh 96-well plates and stored at −80° C.

Proteins expressed from this reaction were evaluated by anti-GST Western blotting for bands matching the expected molecular weight of the fusion proteins. The in vitro process yielded approximately 80 micrograms of purified protein per ml of reaction mixture, whereas expressing the same proteins in E. coli in vivo produced only about 8 micrograms per ml of expression culture. Proteins passing Western QC were re-arrayed and placed into 384-well spotting plates for microarray printing. Over 2700 proteins, representing 67% of the Y. pestis proteome, were produced.

A contact-type printer equipped with 48 matched quill-type pins was used to deposit each of these proteins, along with a set of control proteins, in duplicate spots on 1 inch×3 inch glass slides coated with a thin layer of nitrocellulose (FAST® Slides, Whatman, Incorporated, Florham Park, N.J.). Printing was carried out in a cold room under dust-free conditions in order to preserve the integrity both of samples and printed microarrays. Each lot of slides was subjected to rigorous quality control (QC) procedures including a gross visual inspection to check for scratches, fibers and smearing; a GST-directed antibody was used to detect Y. pestis proteins. Proteins were diluted in printing buffer containing glutathione, which exhibits autofluorescence when scanned at 532 nm. This autofluorescent signal was captured through scanning representative arrays in a procedure that measures variability in spot morphology, the number of missing spots, presence of control spots, and the amount of protein deposited in each spot. These arrays were designed to accommodate 19,200 spots. Samples were printed in 130 μm spots arrayed in 48 subarrays (4000 μm² each) equally spaced in vertical and horizontal directions, with 16 columns and 16 rows per subarray and 275 μm spot-to-spot spacing. An extra 500 μm gap between adjacent subarrays allows quick identification of subarrays.

A powerful means of determining protein function is to map its interactions with other proteins. Several products have recently been introduced (Invitrogen Corporation) that establish a new paradigm for studying protein interactions on a proteome scale. Two of these products are the PROTOARRAY™ Yeast Proteome Microarray, which contains 4088 different proteins from Saccharomyces cerevisiae, and the PROTOARRAY™ Human Protein Microarray with over 5000 human proteins. For both products, all proteins are expressed as N-terminal Glutathione S-Transferase (GST) fusion proteins and then purified and spotted in duplicate on a nitrocellulose-coated 1 inch×3 inch glass slide (GENTEL® BioSciences, Incorporated, Madison, Wis.). Using these PROTOARRAY™ products, proteins of interest can be screened for interactions with thousands of other proteins in as little as four hours. Detection on the arrays is sensitive (as little as 1 pg of protein on the array can be detected with submicrogram quantities of probe protein) and reproducible.

The utility of pathogen proteome arrays have been validated for measuring protein-protein interactions using several documented Y. pestis protein-protein interactions. One such set includes the interactions between proteins in the Y. pestis Type III secretion system, for example YopH, YopE or YopD and the cognate chaperones SycH, SycE and SycD, respectively (Swietnicki, et al., J. Biol. Chem. 279:38693-38700, 2004). When SycH was expressed as a GST-fusion protein, affinity-purified, biotinylated, and used to probe the Y. pestis proteome microarray, the expected interaction with YopH on the array was observed.

A total of thirty-five Y. pestis arrays were used to run serum profiling assays. Sera from one normal human donor, one normal (unvaccinated) rabbit, and one immune rabbit (vaccinated with a Y. pestis lysate) were tested using material provided by USAMRIID. In addition, commercially procured pooled serum samples from cynomolgus macaques (3), rhesus macaques (3), rabbits (3) and mice (3) were run. A total of 45 Y. pestis proteins were observed to have significant reactivity in one or more of the animal species tested. A subset comprising fourteen of these proteins were reactive with all samples of two or more species; two proteins were consistently reactive with all three ALEXAFLUOR®-conjugated probes. The single sample of normal human serum reacted with eight of these proteins, and thirteen others. The normal rabbit serum reacted with eleven Y. pestis proteins (Z-score>5), including three that were reactive with the ALEXAFLUOR® probe. The Y. pestis lysate immune rabbit serum reacted with an additional ten proteins on the array.

Recently, a protein microarray representing 149 Y. pestis proteins was developed and used to profile antibody responses in EV76-immunized rabbits (Li, et al., Infect. Immun. 73:3734-3739, 2005). There were 11 proteins besides F1 and V antigens to which the predominant antibody response occurred, suggesting that they hold promise for further evaluation as candidates for subunit vaccines and/or diagnostic antigens.

In order to increase the content of the Y. pestis protein array, ORF clones that had previously failed subcloning or that had previously failed protein expression were reattempted. In addition, clones that had not previously been tested for expression were used for protein production. Entry clones were sub-cloned into the pEXP1-GST expression vector via standard GATEWAY™recombination. Size validation of destination clones was performed by PCR amplification of overnight-grown colonies. One of four destination colonies that matched the expected insert size was selected and re-arrayed. Plasmid DNA was purified from destination clones using a PERFECTPREP® Plasmid 96 Spin, Direct Bind kit (Eppendorf North America). Final DNA elution was performed with two successive volumes that were combined after each spin through the binding plate. Entire 96-well plates of purified destination plasmid were evaluated for DNA concentration using the QUANT-IT™ Broad Range Kit (Invitrogen Corporation). After determining DNA concentration, a spot check for DNA quality was performed on a low resolution agarose gel using the E-GEL® 96 system (Invitrogen Corporation). Newly produced destination clones were evaluated for correct gene identity by performing a single sequencing read on purified plasmid.

A plasmid re-array was performed on plasmids that failed the first pass of expression/purification. These clone plus the clones that had not previously been attempted for expression were expressed using the EXPRESSWAY™ Cell Free Expression System (Invitrogen Corporation). A stock solution of EXPRESSWAY™ reaction mix composed of E. coli extract, reaction buffer, amino acids and T7 RNA polymerase enzyme mix was prepared and dispensed, followed with either purified plasmid DNA or the expression-verified positive control expression plasmid pEXP-GST-CALML3. The plate was sealed and incubated under optimum conditions for protein expression.

Following centrifugation, supernatants were transferred to a fresh deep well plate. A 50% slurry of wash buffer-equilibrated, glutathione-sepharose was added to the supernatant in each well; the plate contents were then transferred to a filter plate, and centrifuged. Resin was retained and washed; bound protein was eluted using a buffer containing 20 mM reduced glutathione. Supernatants containing eluted protein were transferred to fresh plates and stored at −80° C. Proteins were evaluated for correct molecular weight by SDS-PAGE followed by SYPRO® Ruby (Invitrogen Corporation) staining. Rather then binding to protein, SYPRO® Ruby associates with the primary amines and allows detection via a fluorescent signal that is linear over three orders of magnitude. Proteins that passed this QC were re-arrayed and assembled for microarray printing. The output of all of the protein purification processes described above produced a total of 3733 unique Y. pestis proteins suitable for printing on arrays. A contact-type printer equipped with 48 matched quill-type pins was used to deposit each of the newly identified proteins, along with a set of control proteins, in duplicate spots on 1 inch×3 inch glass slides coated with a thin layer of nitrocellulose (PATH® Slides, GENTEL® BioSciences, Incorporated). Printing was carried out in a cold room under dust-free conditions in order to preserve the integrity both of samples and printed microarrays. Each lot of slides was subjected to rigorous quality control (QC) procedures including a gross visual inspection to check for scratches, fibers and smearing; a GST-directed antibody was used to detect Y. pestis proteins. Proteins were diluted in printing buffer containing glutathione, which exhibits autofluorescence when scanned at 532 nm. This autofluorescent signal was captured through scanning representative arrays in a procedure that measures variability in spot morphology, the number of missing spots, presence of control spots, and the amount of protein deposited in each spot. These arrays were designed to accommodate 19,200 spots. Samples were printed in 130 μm spots arrayed in 48 subarrays (4000 μm² each) equally spaced in vertical and horizontal directions, with 16 columns and 16 rows per subarray and 275 μm spot-to-spot spacing. An extra 500 μm gap between adjacent subarrays allows quick identification of subarrays.

A subset of the arrays was then subjected to Immune Response Profiling (“IRP”). The PROTOARRAY® Immune Response Biomarker Profiling Application Kit (Invitrogen Corporation) was used according to the manufacturer's protocol. Briefly, all steps should be generally carried out at 4° C. Take care not to touch the surface of the microarrays. Block the microarray with 5 ml of Blocking Buffer (50 mM HEPES, pH 7.5, 200 mM NaCl, 0.08% Triton X-100.25% glycerol, 20 mM reduced glutathione, 1 mM DTT (optional), 40 mM NaOH, 1% BSA (added immediately prior to use)) with gentle agitation (use a shaker that keeps the microarrays in one plane during rotation to reduce cross-well contamination) in 4-well trays for 1 hour at 4° C. Remove Blocking Buffer by either aspiration with vacuum or by pipetting. Add 5 ml diluted serum (1:500, recommended) in PBST Buffer (1×PBS (dilute 10×PBS, pH 7.4 (GIBCO®, Invitrogen Corporation), 1% BSA (dilute 30% BSA protease-free solution (Sigma-Aldrich Corporation, St. Louis, Mo.), added immediately prior to use), 0.1% Tween 20 (American Bioanalytical, Natick, Mass.) and incubate 90 minutes with gentle agitation at 4° C. Remove serum sample by aspiration with either vacuum or by pipetting. Wash with 5 ml fresh PBST Buffer, 5 minute incubations per wash with gentle agitation. Remove PBST Buffer by aspiration with either vacuum or by pipetting. Repeat 4 times. Add 5 ml secondary antibody diluted in PBST Buffer, and incubate 90 minutes with gentle agitation at 4° C. Remove secondary antibody solution by aspiration with either vacuum or by pipetting. Wash with 5 ml fresh PBST Buffer, 5 minute incubations per wash with gentle agitation. Remove PBST Buffer by aspiration with either vacuum or by pipetting. Repeat 4 times. Dry slides by centrifugation for one minute at 1000 rpm in a plate-carrier rotor. Scan slide with fluorescent microarray scanner (GENEPIX® 4000B, Molecular Devices, Sunnyvale, Calif.) at 635 nm with a PMT gain of 600, a laser power of 100% and a focus point of 0 μm. Acquire data with microarray analysis software (GENEPIX® Pro, Molecular Devices), and analyze data with appropriate data analysis software (PROTOARRAY® Prospector, Invitrogen Corporation).

Seven Y. pestis microarrays manufactured using FAST® nitrocellulose slides were profiled with purified Y. pestis-specific antibody reagents (2 mAbs to F1, 2 mAbs to V antigen, 1 rabbit pAb), along with sera from immunized rabbits and normal rabbit sera controls. Antibodies were applied at 1 μg/ml and probed with species IgG-appropriate ALEXA FLUOR® 647 secondary reagent, according to the IRP assay protocol detailed above. Results for each antibody were compared to those from a control slide exposed only to the corresponding ALEXA FLUOR® probe. Hits were scored using a Z-score threshold of 3; in the rabbit samples hits were scored using a Z-score threshold of >5.

A purified rabbit anti-Y. pestis pAb and profiled according to the protocol detailed above showed significant binding (Z-score>5) with six proteins. Of note are the common immune hits 2,3,4,5-tetrahydropyridine-2-carboxylate N-succinyltransferase, which maps to the gene dapD, and groEL protein, which maps to mopA.

Monoclonal antibodies to the F1 capsular antigen were purchased from Virostat (Portland, Me., mAb 6031) and from BIODESIGN International (Saco, Me., clone YPF19), with suspicion that they were two sources for the same antibody. Microarray profiling results showed identical reactivity patterns of both mAbs on Y. pestis proteins, suggesting that they are indeed the same YPF19 clone; they share a single significant immune determinant, y2727 (CoA binding protein on pMT). Interestingly, no binding to any of four F1 determinants on this array was observed.

Monoclonal antibodies to V antigen determinants described as a capture-detector pair for immunoassay were purchased from BIODESIGN International (clones Val 3 and Va48). Microarray profiling results showed each to bind a single unique reactive protein: Val3 to y2274 (oxidoreductase component), Va48 to y2054 (hypothetical protein).

Vaccinia var. Copenhagen

Primer pairs were designed to amplify coding sequences and produce fragments with termini that were appropriate for cloning into the GATEWAY™ Entry vector pENTR221. PCR amplification from genomic DNA was carried out in 96-well plates, using a high fidelity polymerase to minimize introduction of spurious mutations. The resulting amplified products were tested for the correct or expected size using a CALIPER® AMS-90™ analyzer (Caliper Life Sciences Corporation) and PROTOMINE™ software (Protometrix, Incorporated, Guilford, Conn.). All cloning steps were carried out in bar-coded 96-well plates using robotic liquid handling equipment. These steps included solid-phase DNA purification, BP recombinational cloning reactions, and transformation into competent E. coli. Four colonies were picked from each transformation using a colony-picking robot. PCR reactions and QCs of each reaction were carried out on each colony in an automated fashion as described above. Two colonies with the correct sized PCR fragment were robotically consolidated into bar-coded 96-well plates, and the product TEMPLIPHI™ (GE Healthcare, Chalfont St. Giles, United Kingdom) was used to create templates for automated DNA sequencing.

Clones were sequence-verified through the entire length of their inserts. A set of highly efficient algorithms have been developed that can automatically determine whether the sequence of a clone matches the intended gene, whether there are any deleterious mutations, and whether the ORF is correctly inserted into the vector. For the cloning part of this process, 255 out of 273 vaccinia genes (93%) were successfully cloned and sequenced. Only clones that had the correct sequence were made available for protein expression.

Next, sufficient amounts of recombinant poxvirus proteins were produced for production of vaccinia protein microarrays. Since the smallpox and vaccinia viruses use the cellular machinery of infected eukaryotic cells for protein synthesis, an insect cell-based system was used for protein production. Recombinant proteins expressed in insect cells have a high frequency of proper folding, high yield, and post-translational modifications (e.g., phosphorylation and glycosylation) that are similar to mammalian cells (Bouvier, et al., Curr. Opin. Biotechnol. 9:522-527, 1998; Hollister, et al., J. Biochemistry 41:15093-15104, 2002; Predki, Curr. Opin. Chem. Biol. 8:8-13, 2003). These desirable features are in contrast to such proteins expressed in E. coli, which are often not folded properly and lack post-translational modifications. A baculovirus-based system was adapted for highly efficient expression of mammalian proteins in a 96-well format. Optimization of this process has allowed us to routine achievement of an 80% or higher success rate in obtaining soluble recombinant proteins from 96-well insect cell cultures (Schweitzer, et al., Proteomics 3:2190-2199, 2003); this rate of success represents a significant improvement over the 42% success rate that had been previously reported (Braun, et al., Proc. Natl. Acad. Sci. USA 99:2654-2659, 2002; Gilbert and Albala, Curr. Opin. Chem. Biol. 6:102-105, 2002) in this format.

The baculovirus-based expression system involves the use of a “bacmid” shuttle vector in an E. coli host containing a transposase. Sequence-validated ORFs were cloned via recombination into the GATEWAY™ destination vector pDEST20. Thus, the vectors used have sequences needed for direct incorporation into the bacmid, as well as the additional elements required for baculovirus driven over-expression, including an antibiotic resistance marker, a polyhedrin promoter, an N-terminal glutathione-S-transferase (GST) tag, and a polyadenylation signal. Just as in the cloning process described above, sets of genes queued for expression were created and processed as single units of bar-coded 96-well plates. Selected genes (and controls) were robotically re-arrayed for transformation into the bacmid-containing E. coli strain. Following transformation, colonies were picked robotically, and correct integration of the cloned gene into the bacmid was checked by PCR. Isolated bacmid DNA was transfected into insect cells and formed competent virus particles that were propagated by successive insect cell infections and were amplified to a high titer. Aliquots of amplified viral stocks were used to infect insect cell cultures in bar-coded 96 deep-well plates. Following a 3-day growth, the insect cells containing expressed proteins were collected and lysed in preparation for purification.

A high-throughput protein purification process was optimized and automated so that hundreds of different proteins can be purified in a single day in a 96-well format. All steps of the process including cell lysis, binding to affinity resins, washing, and elution, have been integrated into an automated process that is carried out at 4° C. Insect cells were lysed under non-denaturing conditions and lysates were loaded directly into 96-well plates containing glutathione-agarose for affinity-based purification. This resin is highly effective in purifying GST-tagged proteins to greater than 90% purity in a single step. After washing, purified proteins were eluted under conditions designed to obtain native proteins.

After purification, samples of the purified material were run out on SDS-PAGE gels and immuno-detected by Western blot using an anti-GST antibody. The gel images were electronically captured and processed to generate a table of all the protein molecular weights detected for each sample, which is uploaded into a database. The protein sizing data were automatically scored for the presence or absence of a dominant band at the correct expected molecular weight. In total, 179 out of the 212 (84%) clones submitted for expression passed Western QC after purification. Following purification, purified proteins that passed Western QC were aliquoted into 384-well plates suitable for microarray manufacture and stored at −80° C. until use.

Microarrays printed with hundreds to thousands of different purified functional proteins can be routinely produced. The utility of these arrays has been demonstrated for a wide variety of applications, including mapping protein-protein, protein-lipid, protein-DNA, and protein-small molecule interactions, measuring post-translational modifications, and carrying out biochemical assays (Zhu, et al., Nat. Genet. 26:283-289, 2000, Zhu, et al., 2001, supra, Predki, 2003, supra, Schweitzer, et al., 2003, supra, Michaud, et al., 2003, supra). The production of these microarrays requires only a small amount of each protein—1 microgram of each protein is sufficient to print hundreds of arrays. Aliquots of each purified protein were robotically dispensed in buffer optimized for microarray printing into microarrayer-compatible bar-coded 384-well plates. The contents of these plates along with plates of proteins used as positive (e.g., fluorescently-labeled proteins, biotinylated proteins, etc.) and negative (e.g., BSA) controls were spotted onto 1 inch×3 inch microscope slides using a microarrayer robot equipped with 48 quill-type pins. Each protein was spotted in duplicate with a spot-to-spot spacing of 250 microns. Pins were extensively washed and dried after each dispensing cycle to prevent sample carry-over.

A typical lot of microarrays generated from one printing run consists of 100 slides. Since each of the proteins is tagged with an epitope (e.g., GST), representative slides from each printing lot were QC'd using a labeled antibody that is directed against this epitope. Every slide is printed with a dilution series of known quantities of a protein containing the epitope tag. QC images were uploaded into a database that calculates a standard curve and converts the signal intensities for each spot into the amount of protein deposited. The intra-slide and intra-lot variability in spot intensity and morphology, the number of missing spots, and the presence of control spots was also measured. Arrays that pass a defined set of QC criteria were stored at −20° C. until use.

Felgner and co-workers generated protein microarrays of a near-complete vaccinia proteome (Davies, et al., 2005(a), supra). Although the methods used to construct these arrays had some significant drawbacks, they were used to determine the major antigen specificities of the human humoral immune response to the smallpox vaccine (DRYVAX®). H3L, an intracellular mature virion envelope protein, was consistently recognized by high titer antibodies in the majority of human donors, particularly after secondary immunization.

The present protein arrays improves upon previous work with pathogen arrays by (1) employing rigorous quality control on the cloned genes to ensure that the sequence is identical to reference databases, (2) using purified proteins that have been checked for proper concentration and molecular weight, (3) using an appropriate expression host, and (4) manufacturing arrays according to commercially acceptable specifications. Pathogen arrays produced according to these standards provide superior data quality when used to profile serum antibodies.

A contact-type printer equipped with 48 matched quill-type pins was used to deposit each of the vaccinia proteins, along with a set of control proteins, in duplicate spots on 1 inch×3 inch glass slides coated with a thin layer of nitrocellulose (FAST® Slides, Whatman, Incorporated, Florham Park, N.J.), as detailed above for Y. pestis. A total of forty-four vaccinia protein arrays were used to run serum profiling assays. Commercially procured sera from twenty-three normal human donors aged 19-57 (thirteen males, ten females), showed universal reactivity with nine proteins, including some that are also reported (Davies, et al., 2005(a), supra) to be reactive in naive (non-immunized) human sera: F8L (hypothetical protein), O2L (glutaredoxin), H7R (hypothetical protein), A31R (hypothetical protein), C7L (hypothetical protein), A47L, and E6R; two proteins commonly observed as reactive in known immune sera showed significant binding in the normal donors: A33R (EEV glycoprotein), A25L. Differences in assay parameters (virus strain, cloning and protein expression methods, identity and quantity of proteins spotted on arrays, specificity of secondary antibody probe and efficiency of fluorophore, and analysis algorithm) likely accounted for differences observed in normal serum reactivity patterns.

Commercially procured serum pools from rhesus macaques were run and analyzed in the same manner and showed significant binding (Z-score>3) on four proteins (C7L, F8L, O2L, H7R), all of which were also reactive with the ALEXA FLUOR®-labeled probe. A single protein (K7R—hypothetical protein) was reactive in all four samples. Five proteins included in reactivity patterns of immune sera (I3L (DNA-binding phosphoprotein), L4R, A13L, A27L (cell fusion protein), A33R) were common reactants in these macaque sera, suggesting presence of vaccinia or a similar virus in the primate colonies. A single sample of normal rabbit serum and two samples of pooled normal mouse serum showed significant reactivity with the four proteins (F8L, O2L, H7R, A31R); in addition, the mouse sera reacted with C7L and K7R. In addition, one sample of mouse serum was highly reactive with four proteins found in immune sera: I3L, H3L (IMV membrane-associated protein), DI3L (rifampicin resistance protein), and A33R. Three samples of vaccinia-immune serum were tested on these arrays: a pooled human vaccinia immune globulin (VIG) product (Cangene Corporation, Winnipeg, Canada), and gifts of immune rabbit and mouse serum from the University of Texas (Galveston, Tex.) (one each). Six proteins were significantly reactive (Z-score>3) in VIG: I1L (putative DNA-binding virion core protein), I3L, H3L, DI3L, A27L, and A33R. Eleven proteins significantly reacted with the immune rabbit serum: C3L (complement regulatory protein), I3L, H3L, H5R (late transcription factor), H7R, D4R (uracil DNA glycosylase), DI3L, A6L (hypothetical protein), A27L, A33R, and B20R (hypothetical protein). A subset of five of these proteins was significantly reactive with immune mouse serum: H3L, H7R, A6L, A27L, A33R.

To increase vaccinia virus proteome coverage and the quality of proteins on microarrays, second attempts of PCR amplification, cloning, and/or subcloning were initiated on 41 ORFs and 214 entry clones. In addition, clones that had not been previously tested for expression were used for protein production.

All cloning, expression, purification, and arraying procedures are linked to a database and workflow management system called PROTOMINE™ (Invitrogen Corporation), which both organizes and tracks the progress from gene sequences to validation of printed protein arrays (Ball, et al., 2005, supra). Primer pairs were automatically designed by PROTOMINE™ to amplify coding sequences and produce fragments with termini appropriate for cloning into the GATEWAY™entry vector pENTR221.

PCR amplification was carried out using a high fidelity polymerase to minimize introduction of spurious mutations. The resulting amplified products were tested for the correct or expected size and uploaded for automatic comparison to the gene size expected for each. PROTOMINE™ used the results to direct a re-array that consolidated PCR products into a single plate for recombinational cloning into pENTR221. Steps include solid-phase DNA purification, BP recombinational cloning reactions, and transformation into competent E. coli. Four colonies were picked from each transformation; PCR reactions and QC of each reaction were carried out on each colony as described above.

Clones that previously passed sizing PCR analysis were fully sequenced in one or two steps, flanking and primer walking sequencing, as a final quality analysis. The ORF inserts and recombinational vector regions, attR1 and attR2, of entry clones were analyzed for complete coverage and quality, and compared with expected reference sequences. The analysis was semi automatically performed, and included contig assembling, sequence quality evaluation (Phred >=30), pairwise alignment of clone and reference sequences, and detection of any mutations. First, clone DNA templates for all targets (up to four clones per target) were prepared by rolling circle amplification by TEMPLIPHI™ kit (GE Healthcare) directly from overnight E. coli cultures. Forward and reverse sequences of flanking regions were generated and analyzed as described above. If a target had one or more clones that were fully sequenced and passed quality and mutation analysis, it became available for subcloning into the expression vector of choice. For targets that had all clones with incomplete sequences and/or contigs with low quality regions, one best clone was selected for primer walking sequencing. Selection was based on the longest high quality sequence with no mutations detected in the flanking regions. Clone culture stocks and corresponding data were used for plasmid DNA preparation, walking primer design and sequencing. Resulting sequences were assembled and analyzed as described above, and passed clones were selected for subcloning.

A baculovirus-based system was chosen for highly efficient expression of proteins in a 96-well format, as described above. The baculovirus-based expression system involves the use of a “bacmid” shuttle vector in an E. coli host containing a transposase. Sequence-validated ORFs were cloned via recombination into the GATEWAY™ Destination vector pDEST20, which has sequences needed for direct incorporation into the bacmid, and additional elements required for baculovirus driven over-expression. Entry clones were sub-cloned via standard GATEWAY™ recombination, and purified entry plasmid DNA recombined into the destination vector and used to transform chemically competent DH10B cells. One destination colony that matches the expected insert size was selected and re-arrayed for transformation into the bacmid-containing E. coli strain. Following transformation, colonies were picked and correct integration of the cloned gene into the bacmid checked by PROTOMINE™ after PCR. Isolated bacmid DNA was transfected into insect cells and amplified to a high titer. Aliquots of amplified viral stocks were used to infect insect cell cultures. Insect cells containing expressed proteins were collected and lysed in preparation for purification.

A high-throughput protein purification process was utilized so that more than 5000 different proteins can be purified in a single day. All steps of the process including cell lysis, binding to affinity resins, washing, and elution, have been integrated into a fully automated robotic process that is carried out at 4° C. Insect cells were lysed under non-denaturing conditions and lysates loaded directly into 96-well plates. A 50% slurry of wash buffer-equilibrated, glutathione-sepharose was added to the supernatant in each well, and the plate placed at 4° C.; contents were then transferred to a filter plate and centrifuged. Resin was retained and washed; bound protein was eluted in overnight incubation followed by centrifugation. Supernatants containing eluted protein were transferred to fresh plates and stored at −80° C.

After purification, samples of the purified material were run out on SDS-PAGE gels and were stained using SYPRO® Ruby. Gel images were processed to generate a table of all the protein molecular weights detected for each sample, scored for the presence or absence of a dominant band at the correct expected molecular weight, and stored at −80° C. until further use. This expression process resulted in a significant increase in vaccinia protein yield and increased the total number of vaccinia proteins to 260, representing 95% of the vaccinia proteome.

A contact-type printer equipped with 48 matched quill-type pins was used to deposit each of the newly identified proteins, along with a set of control proteins, in duplicate spots on 1 inch×3 inch glass slides coated with a thin layer of nitrocellulose (PATH® Slides, GENTEL® BioSciences, Incorporated), as detailed above for Y. pestis. Four Vaccinia microarrays manufactured using FAST nitrocellulose slides were profiled with purified Vaccinia-specific antibody reagents (1 mAb, 1 rabbit pAb) and controls using the IRP protocol detailed above. Antibodies were applied at 1 μg/ml and probed with species IgG-appropriate ALEXA FLUOR® 647 secondary reagent. Results for each antibody were compared to those from a control slide exposed only to the corresponding ALEXA FLUOR® probe. Hits were scored using a Z-score threshold of 3.

The vaccinia immune profiling results with immune mouse serum from the University of Texas (Galveston, Tex.) detailed above were compared with data from a mouse anti-vaccinia mAb (TV43) purchased from BIODESIGN International. Interestingly, the two significant hits with this mAb were common both to the immune mouse serum sample and to most “normal” sera: VACV047 (K7R—hypothetical protein) and VACV090 (O2L—glutaredoxin); VACV 090 reacts also with some secondary antibodies.

The immune profiling results detailed above with convalescent immune rabbit serum from the University of Texas (Galveston, Tex.) were compared with data from a purified rabbit anti-vaccinia pAb purchased from BIODESIGN International. On the FAST® arrays, the commercial reagent from a vaccinated animal reacted strongly with just two determinants common to the reactive set of proteins observed in the convalescent sample: VACVgp126 (H3L —IMV membrane-associated protein) and VACVgp188 (A27L—cell fusion protein). No significant reactivity with the ALEXA FLUOR® probe was observed on these determinants.

Immune profiles for the University of Texas and BIODESIGN International rabbit anti-Vaccinia reagents were run on prototype Poxvirus slides arrayed with proteins from both Monkeypox and Vaccinia viruses using the IRP protocol detailed above. Hits were scored using a Z-score threshold of 3.0. Reactivity to H3L was very high for both antibodies, on both of the protein concentrations spotted, and no background reactivity was observed. However, reactivity to A27L was completely absent on one set of spots but significantly present in all samples and ALEXA FLUOR® controls on the second set of spots.

The immune profile determined above on a FAST Vaccinia protein array for the University of Texas rabbit serum included eleven strong hits: C3L, I3L, H3L, H5R, H7R, D4R, DI3L, A26L (hypothetical protein), A27L, A33R, and B20R. On a new PATH slide, this immune serum was found significantly reactive with ten of these eleven (ambiguously with A27L, and not at all with B20R) as well as three others: K1L (hypothetical putative ankyrin 2 protein), F13L (major envelope protein), and I1L. In contrast, the BIODESIGN International rabbit pAb is by far most reactive with H3L and significantly but less so with C3L, I1L, H7R, DI3L, A33R; ambiguously with A27L; not at all with A26L; and uniquely reactive with A10L (major core protein, a new addition to the array).

A sample of pooled normal rabbit serum was profiled using the IRP protocol on a prototype Poxvirus slide and scored as described above. Reactivities with Vaccinia proteins included the same four hits previously observed with a different sample of normal rabbit serum (“NRS”) on FAST slides (F8L, O2L, H7R, A31R) and eight additional proteins: L4R, A4L (hypothetical membrane-associated core protein), C7L, K3L, K1L, A22R, A47L, and VACVgp105 (predicted RNA polymerase). In general, proteins emerging as new reactants on PATH slides showed signals greater than background on FAST slides, but of insufficient intensity to be scored as hits.

Immune profiles were run on Poxvirus slides arrayed with proteins from Monkeypox and Vaccinia viruses using a revised IRP protocol. Briefly, all steps were carried out at room temperature. Take care not to touch the surface of the microarrays. Block the microarray with 5 ml of Blocking Buffer (50 mM HEPES, pH 7.5, 200 mM NaCl, 0.08% Triton X-100.25% glycerol, 20 mM reduced glutathione, 1 mM DTT (optional), 40 mM NaOH, 1% BSA (added immediately prior to use)) with gentle agitation (use a shaker that keeps the microarrays in one plane during rotation to reduce cross-well contamination) in 4-well trays for 1 hour. Remove Blocking Buffer by either aspiration with vacuum. Add 5 ml diluted serum (1:500, recommended) in PBST Buffer (1×PBS (dilute 10×PBS, pH 7.4 (GIBCO®, Invitrogen Corporation), 1% BSA (dilute 30% BSA protease-free solution (Sigma-Aldrich Corporation, St. Louis, Mo.), added immediately prior to use), 0.1% Tween 20 (American Bioanalytical, Natick, Mass.) and incubate 60 minutes with gentle agitation. Remove serum sample by aspiration. Wash with 5 ml fresh PBST Buffer, 5 minute incubations per wash with gentle agitation. Remove PBST Buffer by aspiration. Repeat 2 times. Add 5 ml secondary antibody diluted in PBST Buffer, and incubate 60 minutes with gentle agitation. Remove secondary antibody solution by aspiration. Wash with 5 ml fresh PBST Buffer, 5 minute incubations per wash with gentle agitation. Remove PBST Buffer by aspiration. Repeat 2 times. Dry slides by centrifugation for one minute at 1000 rpm in a plate-carrier rotor. Scan slide with fluorescent microarray scanner (GENEPIX® 4000B, Molecular Devices, Sunnyvale, Calif.) at 635 nm with a PMT gain between 600 and 800, a laser power of 100% and a focus point of 0 μm. Acquire data with microarray analysis software (GENEPIX® Pro, Molecular Devices), and analyze data with appropriate data analysis software (PROTOARRAY® Prospector, Invitrogen Corporation). Hits were scored using Z-scores of at least 3.0.

Immune (vaccinated) individual human donor sera reacted significantly and specifically with the following six proteins: F13L, I1L, H3L, DI3L, A10L, and A33R. In comparison, these same donor sera reacted significantly and specifically in the IRP assay run in the cold with I1L, H3L, A27L, and A33R. In the cold IRP assay, A10L and F13L were present but showed no signal; in the room temperature IRP assay, A27L was present but showed no signal.

Twelve Poxvirus microarrays containing proteins Vaccinia var. Copenhagen were used for IRP assays of immune human sera, normal and immune rabbit sera, and normal primate sera (cynomolgus and rhesus macaques). Reactive vaccinia proteins were tabulated and data compared with findings from the previous lots of arrays manufactured on FAST slides. The Alexa Fluor anti-human IgG reagent reacted somewhat differently with Vaccinia proteins arrayed on FAST slides and on the new PATH slides: hits on C7L and H7R were not seen on the new slides, while reactivities not observed on FAST slides were recorded on PATH slides for A27L, C3L, and B2R. Ambiguous results were obtained (one block negative, one block positive) for A4L and B11R on PATH slides.

Results with cynomolgus and rhesus macaque sera were consistent with previous observations in that hits for all four were recorded on K7R, C7L, F8L, O2L, and H7R; hits for one or more were observed on I3L, L4R, A27L, and A33R (but not on A13L). In addition, all four samples showed reactivity with eleven more proteins; ambiguous results (one block positive, one block negative) were found for A4L and B11R.

Two in-house immune control sera and the Cangene VIG reagent showed reactivities with Vaccinia proteins consistent with those observed above on FAST slides: the same six hits were recorded on I1L, I3L, H3L, DI3L, A27L, and A33R. Additionally, increases (to significance) were observed for H5R and D4R; new hits were seen on L4R, B2R and F13L. Proteins added to the array based on peer-reviewed reports of importance include E3L, A26L (increase in amount of protein), D8L, A10L (reactive with the BIODESIGN International rabbit pAb), A56R, and B20R; surprisingly, the VIG material was completely unreactive with all of them.

Monkeypox strain Zaire (var. 96-I-16)

The Monkeypox virus isolate Zaire-96-I-16 genome contains 202 protein-encoding ORFs. Cloning, expression, and purification of these proteins were carried out in the same manner as described above for Vaccinia. Briefly, PCR amplification primers were designed for protein-coding ORFs as annotated in GenBank. Amplifications were performed on purified genomic DNA provided by USAMRIID using high-fidelity Pfx DNA polymerase. Amplicons were cloned into the pENTR221 entry vector by GATEWAY™ BP recombination. Verified entry clones were subcloned into the pDEST20 GATEWAY™ destination vector by LR recombination. Destination clones were size-verified and plasmid DNA was transformed into DH10Bac host for integration into baculovirus genomic DNA. Baculovirus stocks were created from bacmid DNA in Sf9 insect cells. Proteins expressed in Sf9 cells from viral stocks were purified by glutathione-agarose chromatography and validated by SDS-PAGE and SYPRO® Ruby staining. As a result, 140 proteins (representing nearly 70% of the Monkeypox virus proteome) were produced. These proteins as well as 260 proteins from Vaccinia (Copenhagen isolate) were used to print three hundred protein arrays on nitrocellulose-coated glass slides (GENTEL® BioSciences, Incorporated).

To increase monkeypox virus proteome coverage, second attempts of initial PCR amplification, cloning, and/or subcloning were initiated as described above for the vaccinia project. Clones that had not been previously tested for expression were used for protein production; in addition, expression was carried out using the improved procedure described above. This work resulted in the production of 189 monkeypox proteins, representing >90% of the viral proteome.

Twelve Poxvirus microarrays containing proteins from Monkeypox var. Zaire 96-I-16 and Vaccinia var. Copenhagen were used for IRP assays of immune human sera, normal and immune rabbit sera, and normal primate sera (cynomolgus and rhesus macaques). Reactive vaccinia proteins were detailed above. Reactive MPX proteins were tabulated and compared.

Both Vaccinia-immune rabbit pAbs reacted significantly with ZAI 115. In addition, the University of Texas rabbit serum showed reactivity on five more (ZAI 069, ZAI 070, ZAI 100, ZAI 122 and ZAI 127); the BIODESIGN International antibody reacted with two others (ZAI 110 and ZAI 126). The sample of normal rabbit serum tested was completely negative on all Monkeypox proteins. All three of the vaccinated/immune human samples reacted strongly with ZAI 115; the VIG material and Milvax-immune donor reacted also with ZAI 067.

Of the unvaccinated nonhuman primate sera tested, one cynomolgus serum sample reacted with twelve determinants to which no signal was observed with rhesus samples. One sample of either species reacted to ZAI 156; one rhesus sample was uniquely reactive with ZAI 178. Both cynomolgus and one rhesus sample reacted to ZAI 100, ZAI 120, ZAI 127, and ZAI 149. Reactivities in unvaccinated primates to determinants of Vaccinia and Monkeypox viruses, in common with specific reactivities observed in vaccinated subjects (ZAI 067, ZAI 069, ZAI 127) suggests that these primate colonies were not free of poxvirus. Reactivity common to immune human and rabbit sera was seen on ZAI 115.

Twenty-four protein arrays containing proteins from Monkeypox Zaire, Monkeypox Sierra Leone (WRAIR), and from Vaccinia var. Copenhagen were used to profile normal and Vaccinia-immune human sera, and normal non-human primate, rabbit, and mouse sera. Both of the Vaccinia-immune human sera reacted significantly and specifically with seven Monkeypox Zaire proteins (ZAI 048, ZAI 067, ZAI 098, ZAI 115, ZAI 126, ZAI 146, and ZAI 153). Consistent with the results detailed above of IRP studies with normal non-human primate sera, one cynomolgus serum sample reacted with a number of Monkeypox Zaire determinants to which no reactivity was observed with other cynomolgus or rhesus serum samples.

Monkeypox Strain Sierra Leone (var. WRAIR)

The Monkeypox virus strain Zaire-96-I-16 originated from the Congo basin and has a different clinical and infectious profile from the strain isolated in a 2003 outbreak in the United States that was traced back to the West Africa region (Likos, et al., J. Gen. Virol. 86:2661-2672, 2005). A genomic DNA sample of this strain, MPXV-WRAIR7-61, was used in this study. In order to identify differentiated ORFs, the amino acid sequences of 177 monkeypox virus strain MPXV-WRAIR7-61 protein coding ORFs as annotated for GenBank accession number AY603973 were compared against 202 ORFs of strain Zaire_{—}1979-005 (GenBank accession number DQ011155). One hundred eighteen ORFs were detected having change(s) in at least one amino acid, insertion/deletion and/or length. Cloning and subcloning of these ORFs was carried out as described above for Vaccinia.

Out of 118 ORFs, 115 (97.5%) were successfully amplified, cloned into pENTR221 vector and fully sequenced. ORFs from entry clones were subcloned into the pDEST20 destination vector and integrated into Baculovirus shuttle vector for expression in insect cells. Cloning, expression, and purification of these proteins were carried out in the same manner as described above for Vaccinia and Monkeypox Zaire viruses. Briefly, PCR amplification primers were designed for protein-coding ORFs as annotated in GenBank. Amplifications were performed on purified genomic DNA using high-fidelity Pfx DNA polymerase. Amplicons were cloned into the pENTR221 entry vector by GATEWAY™ BP recombination. Verified entry clones were subcloned into the pDEST20 GATEWAY™ destination vector by LR recombination. Destination clones were size-verified and plasmid DNA was transformed into DH10Bac host for integration into baculovirus genomic DNA. Baculovirus stocks were created from bacmid DNA in SJ9 insect cells. Proteins expressed in SJ9 cells from viral stocks were purified by glutathione-agarose chromatography and validated by SDS-PAGE and SYPRO® Ruby staining. One hundred and eight proteins (representing nearly 92% of the Monkeypox virus non-redundant proteome) were produced.

These proteins as well as 260 proteins from Vaccinia (Copenhagen isolate) and 140 proteins of Monkeypox Zaire isolate were used to print one hundred and twenty six protein arrays on nitrocellulose-coated glass slides (GENTEL® BioSciences, Incorporated). Samples were printed in 130 μm spots arrayed in 48 subarrays (4000-μm² each) and are equally spaced in vertical and horizontal directions with 16 columns and 16 rows per subarray with 275 μm spot-to-spot spacing. Both of the Vaccinia-immune human sera reacted with only a single Monkeypox WRAIR protein (WRAIR gp115). In contrast to their immune profiles on Monkeypox Zaire, all three cynomolgus serum samples and one rhesus sample reacted strongly with a surprisingly large number of the Monkeypox WRAIR proteins, considering the relatively low coverage of the WRAIR proteome.

Bacillus anthracis (var. Ames)

The B. anthracis (var. Ames) genome contains 5817 protein-encoding genes localized on a chromosome and two plasmids. The current open reading frame (ORF) clone collection from The Institute for Genomic Research (TIGR) contains 5200 clones in a pENTR221GATEWAY™vector. To evaluate integrity, clones were verified by full-length sequencing and by following pairwise alignment to the GenBank reference nucleotide and amino acid sequences.

In order to improve the utility of protein produced in vitro using the EXPRESSWAY™ system (Invitrogen Corporation), the expression vector pEXP7-DEST bearing N-terminal GST-fusion used for production of the Y. pestis proteome was modified with TEV protease cleavage site situated between the GST-tag and attR1 site. The GST tags of proteins made using this vector can be removed using TEV protease. The new expression vector, pEXP7-TEV-DEST, was extensively tested by subcloning of 96 B. anthracis ORFs in parallel with subcloning into pEXP7-DEST vector. Following in vitro expression, SDS-PAGE analysis of purified proteins produced from both vectors revealed no significant difference in protein yield or quality.

Entry clones were next sub-cloned into expression vector pEXP7-GST-TEV via the standard GATEWAY™ recombination protocols described herein. Resulting plasmids were evaluated by end-sequencing and BLAST matched to expected target genes. Expression of GST-tagged proteins from pEXP7-GST-TEV destination plasmids was completed using the EXPRESSWAY™ Cell-Free E. coli Expression System as described for Y. pestis. Proteins expressed using this system were purified by glutathione-agarose chromatography and validated for bands matching the expected molecular weight of the fusion proteins by SDS-PAGE and SYPRO® Ruby staining. Nearly 3700 proteins, representing 60% of the B. anthracis (var. Ames) proteome, were produced. Three hundred arrays were printed on nitrocellulose-coated glass slides (GENTEL® BioSciences, Incorporated). The arrays were designed to accommodate 19,200 spots. Samples were printed in 130 μm spots arrayed in 48 subarrays (4000-1m² each) and are equally spaced in vertical and horizontal directions with 20 columns and 20 rows per subarray with 220 μm spot-to-spot spacing.

In order to increase the content of the B. anthracis protein array, ORF clones that had previously failed subcloning, that had not been subcloned, or that had previously failed protein expression were reattempted. In addition, clones that had not been previously tested for expression were used for protein production. This work was carried out as described above for Y. pestis. Twenty-three B. anthracis (Ames) protein microarrays were used in cold IRP assays of normal and immune human sera, normal rabbit sera, normal mouse sera, and six commercially procured mAbs to B. anthracis (Ames) determinants (two each directed to spore, protective antigen (“PA”), or lethal factor (“LF”)). The mAbs reacted with different sets of proteins; each bound to (a) unique determinant(s), and patterns of overlapping reactivities were observed. Both mAbs to spore and both mAbs to PA reacted with BA3783 (hypothetical protein). Both mAbs to LF reacted with BA0100 (ribosomal protein L7/L12), which also scored as a hit for all three samples of normal rabbit serum, all six samples of normal human serum, and all three immune/suspected exposed human donors; in contrast, normal mouse serum did not react with BA0100. Unique reactivities (Z-score>3) include: mAb 7826 (spore) on BA2509 (transcription regulator/sugar-binding domain), mAb 7827 (spore) on BA0887 (exosporium S-layer protein EA-1); mAb 7821 (PA) on BA3303 (transcriptional regulator, tetR family), mAb 7825 (PA) on BA0100 and BA3783 only; mAb BAL105 (LF) on BA0859 (conserved hypothetical protein) and BA5049 (carbonic anhydrase, prokaryotic type), and mAb BAL106 (LF) on BA2634 (hydrolase, haloacid dehalogenase-like family).

Three individual female mouse sera were tested, with the ALEXA FLUOR® probe as negative control. In one experiment, all three samples reacted to four of these proteins: BA0021, BA0343, BA5196, and BA3821. Similarly, three pooled normal rabbit serum samples all had Z-scores>3 on twelve proteins; for five of them the corresponding negative control score was also scored at >0.5. In common with the normal mouse sera and normal human sera, all three normal rabbit sera reacted with BA3821 (conserved hypothetical protein); the strongest signals were seen on BA0100, BA0397, BA3379, and BA3655.1. Normal rabbit and normal human sera shared common reactivity with BA3655.1 (oxidoreductase, Gfo/Idh/MocA family).

The secondary anti-human IgG reagent, unlike the Fab′₂ conjugates for mouse and rabbit IgG, is a whole-molecule immunoglobulin; it reacts with 40 determinants on the B. anthracis (Ames) array, in contrast to eleven (anti-mouse IgG) and ten (anti-rabbit IgG). Six normal individual human sera (three males and three females, all 20-23 years of age) were profiled on B. anthracis (Ames) arrays. At least three of the six showed reactivity (Z-score>0.5) on a set of 114 proteins with which the ALEXA FLUOR® anti-human IgG reagent did not react; in most cases four or more of these sera were scored as reactive. All six sera reacted with twenty-nine proteins.

Three known or presumed vaccinated/immune human sera were profiled on B. anthracis (Ames) protein arrays: M58 is a multiple-Milvax (military vaccine set) recipient, M19 is a presumed single-Milvax recipient; F54 is long-term exposed to barnyard settings and to laboratory handling of killed Vaccinia virus and purified PA. Results were scored for Z-score>3.0; significant hits were tabulated for determinants unreactive with the ALEXA FLUOR® probe. M58 serum reacted with 73 proteins, strongly (Z-score>5) with thirteen of them. M19 serum reacted with 60 proteins; strongly with four of them, with one of these (BA0100) in common with M58. F54 serum reacted with seventeen proteins; strongly with four of them, three in common with M58 (BA0100, BA3964, BA5446) and one also in common with M19 (BAO100). Unique to F54 was very strong reactivity on BA4877 (S-layer protein, proA domain protein).

Twenty-four extended-coverage B. anthracis (Ames) protein microarrays were used in room temperature IRP assays of normal and immune human sera, and normal non-human primate, rabbit, and mouse sera. Two multiple-vaccinated or presumed immune human sera were profiled on B. anthracis (Ames) protein arrays: M58 is a multiple-Milvax (military vaccine set) recipient, F54 is long-term exposed to barnyard settings and to laboratory handling of killed Vaccinia virus and purified PA. Results were scored for Z-score>3.0; significant hits were tabulated for determinants unreactive with the ALEXA FLUOR® probe. M58 and F54 sera reacted strongly (Z-score>6) with the same/similar proteins as in the cold IRP assay, as well as another dozen not previously giving significant binding signals. It is in this setting (B. anthracis room temperature IRP assay) that the biggest differences between the cold and warm IRP assay results are observed.

Francisella tularensis (tularensis)

Over 1000 proteins (representing 60% of the Francisella tularensis proteome) were produced. The Francisella tularensis Gateway ORF clones were obtained from the Pathogen Functional Genomics Resource of JCVI collection which contains 1744 sequence-validated clones in the GATEWAY™ pENTR211 vector. In order to improve the utility of protein produced in vitro using the EXPRESSWAY™ system, the expression vector, pEXP7-TEV-DEST, with TEV protease cleavage site situated between the GST-tag and attR1 site was used to subclone ORFs. The GST tags of proteins made using this vector can be removed using TEV protease for various post-array purposes. Vector was extensively tested previously and used for by subcloning and expression of B. anthracis ORFs, as detailed above.

Entry clones were next sub-cloned into expression vector pEXP7-GST-TEV via the standard GATEWAY™ recombination protocol described above. Resulting plasmids were evaluated by end-sequencing and BLAST matched to expected target genes. Expression of GST-tagged proteins from pEXP7-GST-TEV destination plasmids was completed using the EXPRESSWAY™ Cell-Free E. coli Expression System as described above for the B. anthracis (Ames) project. Proteins expressed using this system were purified by glutathione-agarose chromatography and validated for bands matching the expected molecular weight of the fusion proteins by SDS-PAGE and SYPRO® Ruby staining.

Entry clones were sub-cloned into the pEXP7-GST-TEV expression vector via standard GATEWAY™ recombination. Size validation of destination clones was performed by PCR amplification of overnight-grown colonies. One of four destination colonies that matched the expected insert size was selected and re-arrayed. Plasmid DNA was purified from destination clones using an Eppendorf PERFECTPREP® Plasmid 96 Spin, Direct Bind kit. Final DNA elution was performed with two successive volumes that were combined after each spin through the binding plate. Entire 96-well plates of purified destination plasmid were evaluated for DNA concentration using the QUANT-IT™ Broad Range Kit (Invitrogen Corporation). After determining DNA concentration, a spot check for DNA quality was performed on a low resolution agarose gel using the E-GEL® 96 system (Invitrogen Corporation). Newly produced destination clones were evaluated for correct gene identity by performing a single sequencing read on purified plasmid.

These clones were expressed using the EXPRESSWAY™ Cell Free Expression System (Invitrogen Corporation). A stock solution of EXPRESSWAY™ reaction mix composed of E. coli extract, reaction buffer, amino acids and T7 RNA polymerase enzyme mix was prepared and dispensed, followed with either purified plasmid DNA or the expression-verified positive control expression plasmid pEXP-GST-CALML3. The plate was sealed and incubated under optimum conditions for protein expression. Following centrifugation, supernatants were transferred to a fresh deep well plate. A 50% slurry of wash buffer-equilibrated, glutathione-sepharose was added to the supernatant in each well; the plate contents were then transferred to a filter plate, and centrifuged. Resin was retained and washed; bound protein was eluted using a buffer containing 20 mM reduced glutathione. Supernatants containing eluted protein were transferred to fresh plates and stored at −80° C. Proteins were evaluated for correct molecular weight by SDS-PAGE followed by SYPRO® Ruby staining. Rather then binding to protein, SYPRO® Ruby associates with the primary amines and allows detection via a fluorescent signal that is linear over three orders of magnitude. Proteins that passed this QC were re-arrayed and assembled for microarray printing.

The output of the protein purification process described above produced 1044 unique F. tularensis proteins suitable for printing on arrays. One hundred arrays were printed on nitrocellulose-coated glass slides (GENTEL™ BioSciences, Incorporated). Samples were printed in 130 μm spots arrayed in 48 subarrays (4000-μm² each) and are equally spaced in vertical and horizontal directions with 16 columns and 16 rows per subarray with 275 μm spot-to-spot spacing. Thirty-nine F. tularensis protein microarrays were used in IRP assays of normal human, non-human primate, rabbit, and mouse sera, as well as two TETRACORE® Incorporated (Rockville, Md.) antibodies to F. tularensis reported to bind vegetative cells: a rabbit pAb, and IgG1 mAb 9A1C10. Eleven out of the 65 hits (17% of those with Z>3) common to more than half of the normal human sera tested were on isoforms of the transposase isftu-1, for which a large number of variants exist. Other proteins reactive with normal human sera include two ABC transporters, several ribosomal proteins, yhhW pirin family protein, a large number of enzymes, chaperonin groES and heat shock protein HSP40. Normal animal sera reacted with fewer than ten F. tularensis proteins scattered throughout the array.

Antibody reagents available from TETRACORE® Incorporated are generated using a whole-organism preparation as immunogen. The polyclonal rabbit IgG and IgG1 mAb 9A1C10 were applied to arrays at 10 μg/ml in the room temperature IRP assay. The rabbit pAb showed significant binding (Z>6) to sixteen proteins, including groES and HSP40. Astonishingly, this mAb failed to react with all F. tularensis proteins on the array.

Dengue, Ebola str. Reston and Zaire, Marburg Lake Victoria str. Musoke viruses

Fourteen annotated genes for each of four strains of Dengue virus were cloned: Dengue virus type 1 strain HawM2516, type 2 strain New Guinea, type 3 strain H87 and type 4 strain H241. In addition ORFs from three Ebola and one Marburg viruses were obtained as described above. The 64 unique ORFs are represented by at least 2 clones/viruses on BAC/virus/expression plates. First-pass cloning/subcloning resulted in 63 unique ORFs in DEST vector, BAC and viruses out of 69 ORFs selected for 4 dengue and 2 Ebola virus (see below) proteomes, a 91% success rate. Also, clones for one Marburg ORF was printed on the microarrays.

Fifty combined Dengue-Ebola-Marburg virus microarrays were used in room temperature IRP assays of normal and convalescent human sera, normal rabbit sera, normal mouse sera, and six commercially procured antibody reagents to Dengue, Ebola/Marburg, and/or West Nile virus determinants. Specific reactivities of anti-Dengue-1 and -2 reagents to DENV-1 and DENV-2 proteins were strong and fairly clear-cut; not so the binding patterns of anti-Dengue-3 and -4 reagents to DENV-3 and DENV-4, which were relatively low and muddy.

Influenza Virus

Viral antigens and immunoglobulins obtained from commercial vendors from various strains of influenza (Table 1, below) were prepared in 8-step 2-fold dilution series in printing buffer and arrayed on nitrocellulose-coated slides (GENTEL® BioSciences, Incorporated) as described above.

TABLE 1

| Vendor SKU | Product Name |
|---|---|
| ab52083 | Hemagglutin protein (HA1-HA2) recombinant |
| ab61301 | HA1 (H3N2) A/Wisconsin aa 12-346 His Tag |
| ab53875 | H5 (H5N1) A/Indonesia aa 18-530 His Tag |
| R86288 | A/Panama/2007/99 |
| R01245 | A/Solomon Islands/03/06 |
| R02302 | A/Texas |
| R02310 | B/Hong Kong/05/772/recombinant |
| R01247 | B/Florida/07/04 recombinant |
| H1N1 New Caledonia | A/New Caledonia/20/99 recombinant |
| H1N1 Texas | A/Texas/36/91 recombinant |
| H3N2 New York | A/New York/55/04 recombinant |
| H5N1 Indonesia | avian A/Indonesia/05/05 recombinant |
| H5N1 Vietnam | avian A/Vietnam/1203/04 recombinant |
| H9N2 Hong Kong | A/Hong Kong/1073/99 recombinant |
| B Hong Kong | B/Hong Kong/330/2001 recombinant |
| B Ohio | B/Ohio/01/05 recombinant |
| RDI-TRK8IN73 | H1N1 A/Taiwan/1/86 purified protein |
| RDI-TRK8IN73-2 | H1N1 A/Beijing/262/95 purified protein |
| RDI-TRK8IN73-3 | H1N1 A/New Caledonia/20/99 IVR116 |
| | purified protein |
| RDI-TRK8IN74 | H3N2 A/Shangdong/9/93 purified protein |
| RDI-TRK8IN74-2 | H3N2 A/Kiev/301/94 like/Johannesburg/33/94 |
| | purified protein |
| RDI-TRK8IN75-2 | Influenza B/Tokio/53/99 purified protein |
| RDI-TRK8IN75-3 | Influenza B/Victoria/504/00 purified protein |
| 171A | PA recombinant |
| 172A | LF recombinant |
| 178A | EF recombinant |

Two volunteer immune donors with known influenza infection and vaccination histories have been profiled: M58, whose exhaustive immunization record includes regular influenza vaccinations, and F54, who has never received an influenza vaccine but has recovered from natural infection. M58 results showed significant reactivity on seventeen different influenza proteins; F54 results showed significant reactivity on thirteen (twelve in common with M58, and A/Texas). The Z-scores of F54 on H1N1 A/Beijing and A/New Calcdonia were significantly higher than those of M58, possibly indicating convalescent antibody to natural infection. In addition, purchased sera from twelve normal human donors will be screened on the influenza arrays: six young (19-21) and six older (41-57) individuals, three males and three females in each group, as well as human clinical-diagnostic control reagents. Antibody reagents of interest will be profiled for reactivity with the anthrax toxin determinants.

The overall goal of the medical research community is to develop knowledge and products to eliminate or minimize the effects of disease and preserve fighting strength. This research develops strategies, products, and information for medical defense against biological warfare threats and against naturally occurring infectious agents of military importance. Medical countermeasures developed to protect military personnel against biological attack include vaccines, therapeutic drugs, diagnostic capabilities, and various medical management procedures. The protein arrays detailed herein provide new military health tools. The most immediate use of the arrays will be as detection systems to determine the presence of threat agents. These arrays will also allow the research community to explore, in new and unprecedented detail, the mechanism by which microorganisms cause disease and the means by which man develops a protective response. The new knowledge generated from these arrays will potentially lead to new diagnostics, vaccines, and therapeutic medicines. These arrays are already proving to be a key enabling technology developed by the life sciences industry to create multipurpose analytical tools for biodefense programs. Ultimately, the products derived from this project can play important roles for intelligence/threat assessment, bioterror response, countermeasure development, force protection, and nonproliferation compliance.

### Example 2

### Immunogen Microarrays

Proof of principle was demonstrated in conventional ELISA by determining antibody titers in purchased clinical diagnostic assay control reagents for IgG and IgM rubella-specific antibody on microtiter plates coated with recombinant rubella peptide antigen. Prototype protein microarrays were then prepared using a purchased collection of off-the-shelf recombinant proteins and inactivated virus preparations, displayed in dilution series in duplicates and spotted on nitrocellulose-coated slides (GENTEL® BioSciences, Incorporated). Array controls were expanded to include dilution series of purified immunoglobulins and Fab′₂ fragments of anti-immunoglobulins from/for a variety of laboratory animals, in addition to the customary human-derived and human-specific reagents. Forty-six microarrays were used in IRP studies with normal animal and human sera, known high-titer human sera, clinical assay calibration reagents, and monoclonal antibodies.

Viral antigens and immunoglobulins obtained from commercial vendors (Table 2 (viral antigens associated with common and military immunizations), Table 3 (immunoglobulins derived from humans and common laboratory animals) and Table 4 (Fab′₂ fragments of antibodies directed against common immunoglobulins), below) were prepared as an 8-step 2-fold dilution series and transferred in 15 μl aliquots to 384-well plates. A contact-type printer equipped with 48 matched quill-type pins was used to deposit each of these proteins along with a set of control proteins in duplicate spots on 1 inch×3 inch glass slides that have been coated with a thin layer of nitrocellulose (GENTEL® BioSciences, Incorporated). Each lot of slides was subjected to the quality control (QC) procedure detailed above. Proteins were diluted in printing buffer containing glutathione which exhibits autofluorescence when scanned at 532 nm. This autofluorescent signal was captured through scanning representative arrays in a procedure that measures the variability in spot morphology, the number of missing spots, and the presence of control spots. Samples were printed in 130 μm spots arrayed in 48 subarrays and were equally spaced in vertical and horizontal directions with 16 columns and 16 rows per subarray. Spots were printed with a 2751m spot-to-spot spacing. An extra 500-μm gap between adjacent subarrays allows quick identification of subarrays.

TABLE 2

| Prospec-Tany Product | Product Description |
|---|---|
| InfluBeijing | Influenza A Virus (H1N1) Beijing 262/95 |
| InfluCaledonia | Influenza A Virus (H1N1) New Caledonia 20/99 IV116 |
| InfluTaiwan | Influenza A Virus (H1N1) Taiwan 1/86 |
| InfluKiev | Influenza A Virus (H3N2) Kiev 301/94 |
| | like/Johannesburg/33/94 |
| InfluPanama | Influenza A Virus (H3N2) Panama 2007/99 |
| InfluShangdong | Influenza A Virus (H3N2) Shangdong 9/93 |
| InfluQingdao | Influenza A Virus Qingdao/102/91 |
| InfluTokio | Influenza A Virus Tokio 53/99 |
| InfluVictoria | Influenza A Virus Victoria 504/00 |
| rDengueNS1c | Recombinant Dengue Virus NS1 c-end |
| rDengueNS3 | Recombinant Dengue Virus NS3 |
| rDengueNS1n | Recombinant Dengue Virus NS3 n-end |
| rHA-Caledonia | Recombinant Hemagglutinin-Influenza A Virus H1N1 New |
| | Caledonia 20/99 |
| rHBsAgadr | Recombinant Hepatitis B Surface Antigen adr subtype |
| rHBsAgadw | Recombinant Hepatitis B Surface Antigen Adw subtype |
| rHCVN24 | Recombinant Hepatitis C Virus Nucleocapsid (core) 24 |
| rHCVNG1a | Recombinant Hepatitis C Virus Nucleocapsid (core) |
| | Genotype 1a (2-119 aa) |
| rHCVNG1b | Recombinant Hepatitis C Virus Nucleocapsid (core) |
| | Genotype 1b (2-119 aa) |
| rHCVNG2a | Recombinant Hepatitis C Virus Nucleocapsid (core) |
| | Genotype 2a (2-119 aa) |
| rHAVVP1 | Recombinant Hepatitis A Virus VP1 (502-605 aa) |
| rHAVVP3 | Recombinant Hepatitis A Virus VP1 (304-415 aa) |
| rHBVX | Recombinant Hepatitis B Virus x |
| rMEVFP | Recombinant Measles Virus fusion protein (399-525 aa) |
| rMEVHM1-30 | Recombinant Measles Virus Hemagglutinin Mosaic |
| | (1-30/115-150/379-410 aa) |
| rMEVLP-29 | Recombinant Measles Virus Large Polymerase |
| | (2059-2183 aa) |
| rMEVLP-58 | Recombinant Measles Virus Large Polymerase (58-149 aa) |
| rMEVNSCP | Recombinant Measles Non-Structural C-Protein (1-51 aa) |
| rMEVN | Recombinant Measles Virus Nucleocapsid (89-165 aa) |
| rRVCC | Recombinant Rubella Virus Capsid C (1-123 aa) |
| rRVE1M | Recombinant Rubella Virus E1 Mosaic |
| | (157-176/374-390/213-239 aa) |
| rRVE2 | Recombinant Rubella Virus E2 (31-105 aa) |
| rTBECE | Recombinant Tick-Born Encephalitis Virus Ce/gE |
| rTBEVC | Recombinant Tick-Born Encephalitis Virus Core |
| rTBEVgE | Recombinant Tick-Born Encephalitis Virus gE (95-229 aa) |
| rTBEVgE-3 | Recombinant Tick-Born Encephalitis Virus gE C-end |
| | (296-414 aa) |
| rTBEVgE-2 | Recombinant Tick-Born Encephalitis Virus gE middle |
| | (50-250 aa) |
| rTBENE | Recombinant Tick-Born Encephalitis Virus Ne/gE |
| rTBENEGECE | Recombinant Tick-Born Encephalitis Virus Ne/GE/CE/gE |
| rTBEVNS3 | Recombinant Tick-Born Encephalitis Virus NS3 |
| rTBEJ | Recombinant Tick-Born Japanese Encephalitis Virus |
| rWNVE | Recombinant West Nile Envelope Virus |
| rWNVPreM | Recombinant West Nile Pre-M Virus |
| Fitzgerald Product | Product Description |
| RDI-HBASOL-AG | Hepatitis A Virus (HAV) |
| RDI-HBVC-AG | Hepatitis B core (HBcAg) |
| RDI-HBS-AG4 | Hepatitis B surface Ag (HBaAg) adr subtype |
| RDI-HBS-AG2 | Hepatitis B surface Ag (HBaAg) subtype Ad |
| RDI-HBS-AG3 | Hepatitis B surface Ag (HBaAg) subtype Ay |
| RDI-HCV204AG | Hepatitis C (NS3) recombinant |
| RDI-HCV205AG | Hepatitis C (NS4) recombinant |
| RDI-HCVP22-AG | Hepatitis C (nucleocapsid) p22 recombinant |
| RDI-TRK8IN73-2 | Influenza A (H1N1) Beijing |
| RDI-TRK8IN75 | Influenza B |
| RDI-MUMPSOL-AG | Mumps virus antigen |
| RDI-TRK8RV78 | Rubella recombinant |
| RDI-RUB293AG | Rubella virus Capsid C 1-123 aa |
| RDI-RUB878AG | Rubella virus E1, E2, and c-core |
| RDI-RUB292AG | Rubella virus E2 310105 aa |
| RDI-RBVSOL-AG | Rubeola (Measles) |
| RDI-VZVSOL-AG | Varicella Zoster Virus antigen |
| RDI-VZV231AG | Varicella Zoster Virus gE 48-135 aa |
| RDI-233AG | Varicella Zoster Virus ORF26 9-33/184-208 aa |
| RDI-VZV232AG | Varicella Zoster Virus ORF9 6-28/76-100 aa |

TABLE 3

| | Product Description |
|---|---|
| Equitech-Bio Product | |
| SLG66-0010 | goat IgG |
| SLGP66-0010 | guinea pig IgG |
| SLHA66-0010 | hamster IgG |
| SLH66-0010 | human IgG |
| SLCM66-0100 | cynomolgus IgG |
| SLRM66-0100 | rhesus IgG |
| SLM66-0100 | mouse IgG |
| SLR66-0010 | rabbit IgG |
| SLRT66-0100 | rat IgG |
| Rockland Product | |
| 006-0102 | GUINEA PIG IgG whole molecule |
| 006-0107 | GUINEA PIG IgM whole molecule |
| 017-0102 | MONKEY IgG whole molecule |
| 017-0107 | MONKEY IgM whole molecule |
| 011-0102 | RABBIT IgG whole molecule |
| 011-0107 | RABBIT IgM whole molecule |
| 005-0102 | GOAT IgG whole molecule |
| 005-0107 | GOAT IgM whole molecule |
| 007-0102 | HAMSTER IgG whole molecule |
| 007-0107 | HAMSTER IgM whole molecule |
| 009-0106 | HUMAN IgA SERUM (not SECRETORY IgA) |
| 009-0102 | HUMAN IgG whole molecule |
| 009-0107 | HUMAN IgM (myeloma) whole molecule |
| 010-001-341 | MOUSE IgA Kappa myeloma protein |
| 010-001-340 | MOUSE IgA Lambda myeloma protein |
| 010-0102 | MOUSE IgG whole molecule |
| 010-001-339 | MOUSE IgM Kappa myeloma protein |
| 010-001-338 | MOUSE IgM Lambda myeloma protein |
| 010-0107 | MOUSE IgM whole molecule |
| 012-0102 | RAT IgG whole molecule |
| 012-0107 | RAT IgM whole molecule |

TABLE 4

| Rockland | Product Description |
|---|---|
| 706-101-002 | F(ab′)₂ Affinity Purified GOAT Anti-GUINEA PIG IgG (H&L) |
| 705-4113 | F(ab′)₂ Affinity Purified RABBIT Anti-GOAT IgG (H&L) |
| | Min X Human Serum Proteins |
| 707-401-002 | F(ab′)₂ Affinity Purified RABBIT Anti-GOLDEN SYRIAN |
| | HAMSTER IgG (H&L) |
| 709-1106 | F(ab′)₂ Affinity Purified GOAT Anti-HUMAN IgA (alpha chain) |
| 709-1112 | F(ab′)₂ Affinity Purified GOAT Anti-HUMAN IgG (gamma chain) |
| 709-1131 | F(ab′)₂ Affinity Purified GOAT Anti-HUMAN IgM Fc5u |
| 710-1131 | F(ab′)₂ Affinity Purified GOAT Anti-MOUSE IgG |
| | Min X Bv Hs Hu Rb Rt & Sh Serum Proteins |
| 710-1107 | F(ab′)₂ Affinity Purified GOAT Anti-MOUSE IgM (mu chain) |
| 709-101-130 | F(ab′)₂ Affinity Purified GOAT Anti-HUMAN IgG IgA IgM (H&L) |
| | Min X MOUSE Serum Proteins |
| 711-1122 | F(ab′)₂ Affinity Purified GOAT Anti-RABBIT IgG (H&L) |
| | Min X Bv Hs Hu Ms Rt & Sh Serum Proteins |
| 712-1133 | F(ab′)₂ Affinity Purified GOAT Anti-RAT IgG (H&L) |
| | Min X Bv Hs Hu Ms Rb & Sh Serum Proteins |

Initial proof of concept was demonstrated by conventional ELISA. A recombinant Rubella VLP protein procured from Fitzgerald Industries was coated onto microtiter plates at 100 ng/well. Positive control human sera for Rubella IgG and IgM purchased from Equitech-Bio were titered on Rubella-coated wells and probed with HRPO anti-human IgG or anti-human IgM.

A RF-positive serum sample was run in the same fashion. Conventional ELISA results are not always the direct equivalent of those from microarrays; optimum amounts/ratios of target protein and overlaid serum can be anticipated to be different.

Recombinant purified viral proteins from a number of viruses infectious to humans were spotted in dilution series on glass slides that have been coated with a thin layer of nitrocellulose (GENTEL® BioSciences, Incorporated), including the Rubella VLP protein. In addition to the customary controls, purified serum immunoglobulins and Fab′₂ fragments of anti-immunoglobulins of/to humans and laboratory animals were spotted in similar dilution series.

These same control antisera were profiled according to the cold IRP protocol and probed with ALEXA FLUOR® anti-human IgG (H+L) or anti-human IgM. Results for the Fitzgerald recombinant Rubella VLP protein were generally consistent with ELISA findings, and similar to those generated on recombinant Rubella envelope proteins (E1 and E2) from ProspecTany Technogene; specific responses of similar magnitude were recorded on 100 nl of all three Rubella proteins. IgG reactivities to Measles, Mumps, and Varicella proteins were also noted. All samples tested showed intense reactivity with all influenza proteins, and specifically on Influenza A H3N2 proteins.

Purchased sera from twelve normal human donors were screened on microarrays: six young (19-21) and six older (41-57) individuals, three males and three females in each group. In addition, two volunteer immune donors with known illness and vaccination histories were profiled. In general, only the highest concentration (100 ng) of proteins spotted on the slides resulted in reliable profile scores except for Influenza A H3N2, for which consistently significant signals were recorded to as little as 12 ng of protein.

Human control reagents (Viroclear/Virotrol pairs for MuMZ, ToRCH and Liquichek+IgM ToRCH, as well as Virotrol WNV) sold for use as calibrators in standard clinical diagnostic immunoassays for Measlesvirus, Mumpsvirus, Varicella zoster, Toxoplasmosis, Rubeola, Cytomegalovirus, Herpesvirus and West Nile virus were profiled on microarrays at an estimated equivalent of a 1:500 serum dilution according to the cold IRP protocol. Again, proteins spotted at 100 ng resulted in the most reliable signals. All of these reagents contained multiple reactivities, with the most extensive binding patterns observed in the Liquichek+IgM. Surprisingly, although other common reactivities were present, the Virotrol WNV reagent showed no reactivity on either of the two WNV proteins (envelope and pre-M) on the array.

The Virotrol WNV reagent was run again at an estimated dilution equivalent of 1:100, along with seven additional anti-WNV reagents already optimized in ELISA: a rabbit antiserum and six mAbs of assorted heavy chain types. Different patterns of cross-reactivity were observed on other viral proteins, but no binding at all was recorded at the WNV protein locations.

### Example 3

### Validation Microarrays

Proteins were selected from those previously found to be either highly immunoreactive with specific antisera or completely unreactive with all sera tested, and expressed in a cell free wheat germ system. Sets of such proteins from four pathogens (Yersinia pestis (KIM), Vaccinia var. Copenhagen, Monkeypox var. Zaire 96-I-16, and Bacillus anthracis (Ames)) were assembled from proteins expressed in either insect cells or E. coli bacteria and in the wheat germ cell free system, and spotted in dilution series on glass slides that have been coated with a thin layer of nitrocellulose (GENTEL® BioSciences, Incorporated). A dozen of these arrays were used to profile reactivities with normal and immune human sera, and normal and immune rabbit sera. Results for corresponding protein pairs were compared and used as part of an internal validation of the cell free wheat germ protein expression system. For Vaccinia and Y. pestis proteins, immune profiles on proteins arrayed on FAST slides and on PATH slides were also compared.

Selected proteins were produced in a cell-free wheat germ system (CellFree Sciences Company, Limited, Matsuyama Ehime, Japan) using a PROTEMIST® DT II instrument (CellFree Sciences Company, Limited) according to the manufacturer's instructions. Briefly, genes of interest were subcloned into the appropriate vector (pEU-GST-TEV-GW) using recombinational cloning as described above. Plasmid DNA from each construct was prepared using the PURELINK™ Maxiprep kit (Invitrogen Corporation). DNA preparations were subsequently combined with the transcription and translation mixtures (supplied through CellFree Sciences Company, Limited, as kit components), and the protein expression and affinity purification via the GST tag were carried out by the PROTEMIST® instrument. Samples were spotted onto custom microarrays in parallel with a dilution series of GST. These custom arrays were subjected to anti-GST staining, and the relative solution concentration was determined by comparison of signal intensities against the standard curve of signals arising from the GST dilution series. Additionally, samples were run on NOVEX® Bis-Tris 4-12% gels (Invitrogen Corporation), and proteins visualized through staining with SIMPLYBLUE™ Safestain (Invitrogen Corporation). Proteins were subjected to quality control through comparison against expected molecular weight. Proteins with an observed molecular weight within 20% of the expected value were carried forward for inclusion on the validation arrays.

Pathogen proteins expressed in Insect Cell, Wheat Germ, or EXPRESSWAY™ expression systems were prepared as an 8-step 2-fold dilution series. A contact-type printer equipped with 48 matched quill-type pins was used to deposit each of these proteins along with a set of control proteins in duplicate spots on 1 inch×3 inch glass slides coated with a thin layer of nitrocellulose (GENTEL® BioSciences, Incorporated). Each lot of slides is subjected to a rigorous quality control (QC) procedure, including a gross visual inspection of all the printed slides to check for scratches, fibers and smearing. Each of the proteins is tagged with GST, detected by GST-directed antibody in a separate QC assay. For the Validation Microarrays, samples were printed in 130 μm spots arrayed in 48 subarrays and are equally spaced in vertical and horizontal directions with 16 columns and 16 rows per subarray. Spots are printed with a 275 μm spot-to-spot spacing. An extra 500 μm gap between adjacent subarrays allows quick identification of subarrays.

Proteins were selected from those found previously on FAST®) arrays (Vaccinia, Y. pestis) and on PATH® arrays (Monkeypox, B. anthracis (Ames)) to be either highly immunoreactive only with specific antibodies or completely unreactive, and expressed in the cell free wheat germ system. Proteins from these four pathogens were arrayed in dilution series on PATH® slides (GENTEL® BioSciences, Incorporated), and probed with normal or immune rabbit and human serum samples according to the cold IRP protocol. Diluted sera were not pre-incubated with E. coli lysate before application to these microarrays, possibly affecting reactivity on those proteins expressed in the E. coli-based EXPRESSWAY™ system and hence comparison with profiles run previously on Y. pestis FAST slides, for which diluted samples were pre-absorbed for 30 minutes with E. coli lysate.

The results suggested that proteins produced in the wheat germ system were glycosylated and/or folded inappropriately for specific immune recognition in mammals. Specific immune titers to Vaccinia H3L (gp126) were insignificant on wheat germ-produced protein in both rabbit and human samples; previously observed immune reactivity to BA0013 in human serum vanished altogether on B. anthracis (Ames) BA0013 produced using the PROTEMIST® DT II. Results on Y. pestis y0609 were indeterminate, possibly due in part to unblocked reactivity with E. coli determinants. Immune serum binding was significantly greater on Monkeypox ZAI 145 expressed in the wheat germ system than on the same protein expressed in insect cells, but net signals were reduced due to corresponding high binding observed in normal serum.

### Example 4

### High Throughput/Automation Microarrays

Proteins from four pathogens (Yersinia pestis (KIM), Vaccinia var. Copenhagen, Monkeypox var. Zaire 96-I-16, and Bacillus anthracis (Ames)) previously found to be either highly immunoreactive with specific antisera or completely unreactive with all sera tested, were spotted in four discrete regions on glass slides coated with a thin layer of nitrocellulose (GENTEL® BioSciences, Incorporated). These arrays are intended for high throughput/multiple-sample studies of immuno-reactivity with normal and immune sera, and will be compared to matched results on corresponding proteins in single-sample arrays. In addition, selected influenza and other virus proteins will be attached to fluorescent beads (Luminex Corporation, Austin, Tex.) and their reactivity patterns compared with matched test sera.

Proteins selected from results on FAST®) arrays (Vaccinia, Y. pestis) and on PATH® arrays (Monkeypox, B. anthracis (Ames)) and tested in the wheat germ expression system microarrays were again arrayed in dilution series on PATH® slides coated with a thin layer of nitrocellulose (GENTEL® BioSciences, Incorporated), this time in four identical subarray grids per slide and spaced to allow overlay of SIMPLEX™ compartment-forming gaskets (GENTEL® BioSciences, Incorporated).

These arrays will be used to assess the practicality of applying multiple serum samples to a single slide, thus saving time and reagents in subsequent steps of the IRP assay. Validation of the protein microarray as diagnostic platform will be addressed by configuring similar/identical assays for a flow cytometer (Luminex Corporation), using selected purified influenza proteins identified in the Influenza study detailed above with matched test sera. Where possible, these test sera will be sent to a local clinical lab for specific antibody titers in standard immunoassays.

### Example 5

### Antibody Response to Yersinia pestis Using a Proteome Microarray

A proteome microarray representing the majority of Yersinia pestis proteins was produced as detailed above and validated for use in measuring global antibody responses. Rabbit hyper-immune sera were produced against proteomes extracted from several pathogenic gram-negative bacteria for use in validation assays. The antibody profile from each of the rabbits enabled detection of: (1) shared crossreactive proteins (2) fingerprint proteins common for two or more bacteria, and (3) signature proteins specific to each pathogen. Unique proteins were recognized by convalescence sera from mice that survived plague following immunization with an experimental F1-V vaccine. Several new antigens were discovered that were recognized by antibody from rhesus that survived plague, whereas these Y. pestis proteins were not recognized by sera from animals surviving challenge with spores of the gram-positive Bacillus anthracis. Finally, analysis of sera from cynomolgus macaques acutely infected with Y. pestis or B. anthracis produced antibody-binding patterns that were unique biomarkers for each disease. These results demonstrate new diagnostic biomarkers, potential vaccine targets, and antigen-cross reactivity between related species of bacteria. All animals used were cared for and used humanely according to the U.S. Public Health Service Policy on Humane Care and Use of Animals (1996), the Guide for the Care and Use of Laboratory Animals (1996), and the U.S. Government Principals for Utilization and Care of Vertebrate Animals Used in Testing, Research and Training (1985). All animal facilities and the animal program are accredited by the Association for Assessment and Accreditation of Laboratory Animal Care International. All animal use was approved by the Institutional Animal Care and Use Committee and conducted in accordance with Federal Animal Welfare Act regulations.

The bacterium Yersinia pestis is responsible for historical epidemics and sporadic contemporary outbreaks of plague throughout the modern world. The plague bacillus evolved from the closely related species Y. pseudotuberculosis, which causes a tuberculosis-like infection of the lung. An understanding of the complex pattern of proteins expressed by Y. pestis that confer pathogenicity is fundamental to the future of diagnostics and medical intervention in plague. At the most basic level the bacterial proteome can be defined by the number of potential gene products. The chromosome of Y. pestis C092 encodes approximately 3885 proteins, while an additional 181 are expressed by pCD1, pMT1, and pPCP1. Approximately 77% of the Y. pestis C092 proteins can be classified by known homologies. Further, there are approximately 150 pseudogenes contained within the genome of Y. pestis C092. For comparison, Y. pseudotuberculosis contains approximately 4038 proteins (chromosome plus plasmids), the proteome of Y. pestis (KIM) contains 4202 individual proteins, 87% in common with CO92, and additional variation in proteome content among other plague isolates is expected. Thus, there does not appear to be a simple relationship between a small number of pathogenic proteins and the more virulent phenotype, but rather multiple, perhaps subtle differences in proteomes. Further, plague bacteria have evolved to survive or grow in burrows inhabited by infected rodents, within the flea gut or phagocytes of mammalian hosts, and finally as an extracellular infection. These different environmental demands are anticipated to evoke unique bacterial proteomes.

It is often difficult to precisely identify infectious agents at the earliest stage of clinical presentation due to the generalized nature of disease symptoms. In addition, infections in the convalescent individual are difficult to identify without culture isolation of pathogen or genetic material. While it is difficult to directly analyze bacterial protein expression during infection, the host antibody response provides a sensitive diagnostic signature. Antibody responses are valid indicators of specific infection if validated antigens are available. For example, the Y. pestis capsular protein CaF1 is frequently used in a simple diagnostic assay. However, additional diagnostic markers are needed because CaF1-negative strains have been isolated and this protein is only expressed during growth at 37° C. Recent technical advances have facilitated the construction of arrays of full-length, functional proteins representative of the nearly complete proteomes. A proteome microarray was prepared as detailed above representing approximately 70% of the proteins expressed by Y. pestis. The microarray was spotted onto glass slides coated with nitrocellulose (GENTEL® BioSciences, Incorporated), following sequence confirmation, high-throughput expression and purification. The proteome microarray was used to identify antibody biomarkers that could distinguish Y. pestis infection from diseases caused by related bacteria.

Microarray slides were imaged using a GENEPIX® 4000B scanner (Molecular Devices) and image analysis was preformed using GENEPIX® Pro 6.0 software (Molecular Devices). Data acquired from GENEPIX®) software was analyzed using PROTOARRAY™ Prospector v3.1 (Invitrogen Corporation) in Immune Response Profiling mode. Data were analyzed by calculation of Chebyshev's Inequality P-value (CI P-value) and Z-Score. Positive-binding events were recorded as Z-Scores>3.5 and CI P-value <0.0003623 (equal to 1/total samples on array).

Approximately 70% of the 4202 potential products from Y. pestis (KIM) chromosomal and plasmid DNA open-reading frames were cloned, sequence verified, expressed, purified using glutathione affinity chromatography and arrayed on glass slides coated with nitrocellulose (GENTEL® BioSciences, Incorporated). Quality control of each protein was evaluated based on protein staining and Western blotting using anti-GST antibody. Proteins were then spotted in duplicate onto the slides. Representative slides from each lot of printed proteome microarrays were QC'd using a rabbit anti-GST antibody and a Cy₅-labeled anti-rabbit antibody.

Rabbit antisera produced against the Y. pestis C092 proteome recognized different Y. pestis strains (India, C092, and Java 9). Microarrays probed with ALEXA FLUOR® 647-labeled streptavidin or biotinylated SycH demonstrated interaction with YopH. Microarrays were also incubated with rabbit hyperimmune sera against the whole Y. pestis proteome (diluted 1:1000), and bound Ig was detected with an ALEXA FLUOR® 647-labeled goat anti-rabbit antibody and detected using a laser confocal scanner. Binding was seen to control proteins and representative arrayed Y. pestis proteins.

Rabbit hyperimmune sera against each bacterial proteome were diluted 1:1000. Following incubation with primary sera, antibody binding was detected with an ALEXA FLUOR® 647-labeled goat anti-rabbit antibody, and detected using a laser confocal scanner. Rabbit anti-Shigella recognizes dysenteriae, boydii, and flexneri, while anti-Salmonella is specific to a broad range of 0 and H strains.

Swiss Webster mice were immunized via intramuscular route with an experimental F1-V plague vaccine and then aerosol challenged with Y. pestis C092. Analysis of convalescent sera from six mice following plague challenge resulted in detection of 13 Y. pestis specific proteins. Six of the 13 proteins were also recognized by sera from a non-immunized mouse that survived challenge, suggesting that vaccination increased the number of recognized proteins and this was independent of titer. No proteins were recognized by sera from a control mouse (non-vaccinated, no challenge).

Several antigens were discovered that were recognized by antibody from immunized rhesus that survived plague, whereas these Y. pestis proteins were not recognized by sera from animals immunized against the gram-positive bacteria Bacillus anthracis that survived challenge with spores. Analysis of sera from cynomolgus macaques acutely infected with Y. pestis or B. anthracis produced antibody-binding patterns that were unique biomarkers for each disease. Z-score comparison of Y. pestis proteins recognized by convalescent sera from rhesus plague survivors and hyperimmune rabbit antisera against Y. pestis proteome resulted in 16 antigenic proteins recognized by Ig from both species, 4 proteins unique to rhesus Ig, and 27 proteins recognized by rabbit Ig that were not recognized by rhesus Ig. Several antigenic proteins significant in rabbit also passed Z-score criteria in rhesus, but not CI-P value criteria, so these proteins were not be considered antigenic. This emphasizes the utility of including both statistical values during microarray analysis to avoid identifying false positives.

### Example 6

### Human Immune Response to Vaccinia

Control of smallpox by mass vaccination was one of the most effective public health measures ever employed for eradicating a devastating infectious disease. However, new methods are needed for monitoring smallpox immunity within current vulnerable populations, and for the development of replacement vaccines for use by immunocompromised or low-responding individuals. As a measure for achieving this goal, a protein microarray of the vaccinia virus proteome was developed by using high-throughput baculovirus expression and purification of individual elements. The array was validated with therapeutic-grade, human hyperimmune sera, and these data were compared to results obtained from individuals vaccinated against smallpox using DRYVAX®. A high level of reproducibility with a very low background were apparent in repetitive assays that confirmed previously reported antigens and identified new proteins that may be important for neutralizing viral infection. The results suggest that proteins recognized by antibodies from all vaccinees constituted less than 10% of the total vaccinia proteome.

World-wide vaccination with attenuated vaccinia virus began in the early 19th century and ended in 1980 after the World Health Organization (WHO) declared smallpox eradicated. A large portion of the population is now especially vulnerable to an infectious outbreak or terrorist attack because most people born after 1971 were not vaccinated against smallpox. The licensed DRYVAX® vaccine, based on the New York City Board of Health (NYCBOH) strain of vaccinia virus, is the standard for the prevention of poxvirus infections in the United States. While very effective, smallpox vaccination is associated with a high rate of adverse events, spurring interest in replacement vaccines.

The development of new smallpox vaccines will first require an inventory of all viral antigens that are necessary to impart and sustain human immunity. However, approaches for the comprehensive identification of smallpox antigens are hampered by the complexity of the virion structure and infective cycle. Variola and vaccinia viruses are large DNA viruses that replicate in the cytoplasm of host cells from genomes encoding 150-300 proteins, with approximately 100 proteins found in virions. Most phenotypic variability occurs in proteins encoded in the terminal regions of the genome that are associated with host virulence or immune evasion. Some of these terminal-region proteins are secreted during cell infection and interfere with host immunity by binding complement factors, cytokines, and chemokines, while others interfere with signaling pathways regulating host gene expression and apoptosis. Each phase of virus production exposes new proteins to potential recognition by host T-cell or antibody-mediated immunity.

Transcription of viral early gene products by enzymes carried in the uncoated core begins immediately upon cell infection and includes proteins required for DNA synthesis. Products of early gene transcription are followed by synthesis of intermediate and late gene products as virus-encoded proteins required for the transcription of each gene class are products of the preceding wave of gene expression. The surface protein coat and lipid membrane are removed during an uncoating process shortly after cell entry by either the extracellular enveloped (EEV) or infectious intracellular mature virus (IMV). Intracellular assembly of new virions begins with the formation of lipid crescents comprised of a double lipid bilayer that develop into spherical immature virus (IV) and finally into IMV particles that contain only one lipid membrane. In addition to these expression-phase dependent variations in viral antigens presented during the infective cycle, potential antigenic differences exist among live viral vaccines due to the effects of attenuation. For example, assembly of modified vaccinia virus Ankara (MVA) is inhibited at a late stage of infection by a block in transport between normal DNA replication sites and normal viral precursor membranes. This block results in a greater amount of IV, leaving few intermediates to reach the IMV form. Further, a recent study reported that many vaccinated individuals lost the capacity to neutralize EEV while most maintained IMV immunity, suggesting a requirement for the revaccination of individuals who have been vaccinated more than 20 years ago (Viner and Isaacs, Microbes Infect. 7:579-583, 2005). Although vaccinia-specific antibodies are sufficient for protection from poxvirus infection, there may also be substantial contributions by cytolytic T-cells and innate immunity.

Recent advances in genomics, high-throughput gene cloning, and protein expression have facilitated the development of protein microarrays consisting of products from all ORFs of the targeted genome. Proteome microarrays are especially advantageous for high-throughput assays because the identities of individual protein elements are referenced, only small quantities of purified protein are required and native folding is often conserved. A microarray of the vaccinia virus proteome was developed and used this to examine the human antibody response to vaccination. The microarrayed proteins were expressed from baculovirus vectors in insect cell culture to maintain eukaryotic translational machinery and secondary protein modifications. All recombinant clones used for arrayed proteins were sequence-verified and extensive array quality control measures were employed to ensure assay performance. The microarrays were validated by screening with therapeutic vaccinia immune globulin (VIg) and further used to identify viral antigens that were recognized by the antibody response of humans to live vaccinia virus.

All cloning steps were carried out in bar-coded 96-well or 384-well plates using robotic liquid handling equipment. Genomic DNA from vaccinia virus, Copenhagen strain (GenBank accession number NC_{—}001559.1), was used as the template for PCR amplification of the 273 ORFs. Primer pairs were designed by to amplify coding sequences and produce fragments compatible for cloning into the GATEWAY® vector pDONR221 (Invitrogen Corporation). PCR amplification was carried out using a high fidelity Pfx DNA polymerase (ACCUPRIME™, Invitrogen Corporation) to minimize the introduction of spurious mutations. After amplification, the products were examined for the expected size using a CALIPER® AMS-90 analyzer (Caliper Life Sciences). PCR products passing sizing QC were gel-purified and used for recombinational cloning into the pDONR221 vector. Reaction products were transformed into competent Escherichia coli DH10B-T1 strain cells. Eight colonies were picked from each transformation and PCR amplified with a generic vector primer to ensure clones contained gene inserts of the expected size. In addition, up to four clones were sequence-verified through the entire length of their inserts. Only one clone containing the correct sequence was used for subsequent protein expression.

For baculovirus-based expression, the sequence-validated ORFs were subcloned via GATEWAY® LR recombination into the destination vector pDEST20 (Invitrogen Corporation). The pDEST20 vector contains sequences needed for the Tn7-mediated site specific in vivo incorporation into the baculovirus/E. coli shuttle bacmid, elements required for baculovirus driven over-expression, including an antibiotic resistance marker, a polyhedrin promoter, an N-terminal GST tag used for recombinant protein purification and detection, and a polyadenylation signal. Vaccinia gene destination clones were transformed into the bacmid-containing E. coli. DH10Bac strain cells. Following transformation, colonies were picked robotically, and the integration of the expression cassette into the bacmid was confirmed by blue-white selection assay on agar plates with Bluo-Gal substrate (Invitrogen Corporation). Isolated bacmid DNA was transfected into Sf9 insect cells to assemble competent virus particles, which were amplified to a high titer by successive rounds of insect cell infection. For expression, aliquots of amplified viral stocks were used to infect insect cell cultures in bar-coded 96 deep-well plates. Following a 3 day growth, the cells were collected and lysed under nondenaturing conditions to collect proteins induced by baculovirus expression. The cell lysates were loaded directly into 96-well plates containing glutathione-agarose, and the GST-tagged proteins were affinity purified to 90% homogeneity in a single step. Purified proteins were analyzed by Western blot assay for sizes and abundance.

Recombinant vaccinia and control proteins were printed onto glass slides coated with nitrocellulose (PATH®, GENTEL® BioSciences, Incorporated) as described above. Protein spot densities of representative slides were measured by using an anti-GST antibody and compared to a dilution series of known quantities of protein that was also printed on each slide. Intraslide and intralot variability in spot intensity and morphology, the number of missing spots and the presence of control spots were also measured and compared to a defined set of standards before use.

Pooled VIg was obtained from Cangene Corporation (Winnipeg, Canada). Consented volunteers (20 male and female) were vaccinated with DRYVAX® and sera were collected prior to and 28 days after a primary or secondary vaccination. Control sera were also collected from volunteers (n=20) who have never received smallpox vaccine. Peripheral venous blood from each donor was collected (10 ml) into serology tubes (Becton, Dickinson and Company, Franklin Lakes, N.J.), centrifuged (2300 rpm, 15 min) and serum was removed for storage (−70° C.) until use.

All microarray assays were performed at room temperature. Microarray slides were incubated (1 hour) with a blocking buffer (1% BSA and 0.1% Tween-20 in PBS). Serum samples were diluted 1:50 and VIg 1:150 in probe buffer (1×PBS, 5 mM MgCl₂, 0.05% Triton X-100, 1% glycerol, 1% BSA) to optimize the signal above background. Diluted sera were overlaid (100 ml) on the slides, covered with glass coverslips, and incubated in a humid environment for 1 hour. Following incubation, cover slips were removed and the slides were washed three times with probe buffer. Antibody binding was detected by incubation with 1:2000 dilution of ALEXA FLUOR®-647 labeled goat antihuman IgG (H+L) (Invitrogen Corporation). The slides were washed three times following incubation with the secondary antibody, and allowed to air dry completely before analysis. Microarray slides were imaged using a GENEPIX® 4000B scanner (Molecular Devices) and image analysis was performed using GENEPIX® Pro 6.0 software (Molecular Devices). Data acquired from GENEPIX® software was analyzed using PROTOARRAY™ Prospector v3.1 (Invitrogen) in Immune Response Profiling mode. Positive binding events were determined by Z-Scores greater than 2.0 and Chebyshev's Inequality p-value less than 0.00502. For cluster analysis, data were preprocessed to remove all controls, average the duplicate protein spots and normalize all the arrays with the global median. A cut-off value of 128 was used to avoid negative values and reduce the influence of noise. Agglomerative hierarchical clustering was performed on log 2-transformed data using Euclidean distance as the dissimilarity metric. All computation and heatmap visualizations were accomplished using the statistics package R.

Vaccinia virus (Copenhagen) genomic DNA was used as a template for PCR amplification in 96-well plates, using a high fidelity polymerase to minimize introduction of spurious mutations. The resulting amplified products were examined for the expected size and sequenced-verified throughout the entire insert length. A total of 251 out of 273 genes (92%) were successfully cloned, and 212 bacmid clones (78%) were successfully converted into baculovirus with correct sequence and used for subsequent protein expression.

An insect cell-based system was used to express the recombinant proteins to ensure high yield and proper folding of proteins, with post-translational modifications that are similar to mammalian cells. Protein expression and purification was optimized and performed in an automated fashion using 96-well plates, resulting in greater than 80% success rate in obtaining soluble recombinant proteins from insect cell cultures. Each protein expressed from the insect cells was tagged with an N-terminal GST tag to facilitate affinity-based purification. Following purification, samples were analyzed by SDS-PAGE gel electrophoresis, stained for the determination of purity, and correct protein size was confirmed by detection with an anti-GST antibody. Out of 212 sequence-verified viruses, 176 unique proteins were successfully purified and passed Western blot QC.

Following confirmation of purity and size, the recombinant proteins were dispensed into 384-well plates for microarray printing. Every slide was printed with a dilution series of known quantities of a GST tagged protein for the calculation of a standard curve that was used to convert the signal intensities for each spotted vaccinia proteins probed with anti-GST antibody. A statistical sampling of each lot of microarrays printed was evaluated for quality and consistency before use. The intraslide and intra-lot variability in spot intensity, morphology, and a full inventory of all arrayed proteins were also confirmed.

The completed vaccinia microarrays were first examined with pooled human vaccinia hyperimmune globulin (VIg) produced for therapeutic treatment of adverse vaccine reactions. The microarrays were incubated with diluted VIg or a pool of sera from nonvaccinated individuals and bound antibody was visualized using fluorescently-labeled antihuman IgG antibody and a confocal laser scanner. Each block of proteins printed on the array had a standard set of positive and negative control protein spots that included anti-GST antibody, an antibiotin antibody and a concentration gradient of human IgG. To aid in the proper orientation and alignment of the scanned array, duplicate spots of ALEXA FLUOR®-647 labeled antimouse antibody were also spotted on the same position of each block.

Incubation of the microarray with VIg identified nine proteins (C3L (complement regulatory protein), I1L (putative DNA-binding virion core protein), I3L (DNA binding phosphoprotein), H3L (IMV membrane associated protein), H5R (late transcription factor), DI3L (rifampicin resistance protein), A27L (cell fusion protein), A33R (extracellular enveloped virus (“EEV”) glycoprotein), and B20R (function unknown, but highly homologous to variola ankyrin-like protein B 18R)) that consistently bound IgG, while antibody interactions with all other proteins were insignificant, requiring no further treatment to suppress nonspecific signals. These antigens were diverse in function, consisting of regulatory, surface, core and secreted proteins. Six of these vaccinia proteins were previously reported to interact with immune sera, while C3L and I1L are newly identified antibody-recognized antigens. The nine antigenic proteins did not bind antibody from nonvaccinated sera, confirming the specificity of these antibody-antigen interactions. However, O2L (glutaredoxin) and H7R (hypothetical protein) were reactive with antibodies from both VIg and nonvaccinated control sera, suggesting that these were crossreactive or nonspecific interactions.

Antibody responses to recent vaccination were next examined. Sera were collected from individuals before and 28 days after receiving a primary or secondary administration of DRYVAX® and a control group of volunteers who had never received the vaccine. All vaccinated volunteers recorded a pustule blister and scab formation at the site of inoculation. Dilutions of sera collected from the control and vaccinated subjects were individually incubated with the vaccinia proteome microarray to measure antibody binding to specific antigens. All proteins recognized by VIg were also detected with antibodies from one or more vaccinated individuals. The hypothetical vaccinia protein B20R, identified by VIg binding, only bound antibody from one individual subject receiving a secondary vaccination, suggesting that antibody responses to this protein on the microarray may only occur with hyperimmune sera. Sera from the majority of control subjects contained IgG that bound to O2L and H7R, confirming that these two antigens were not useful for determining specific immunity to vaccinia. Sera from more than half of the vaccinees contained IgG that recognized at least 4 vaccinia proteins, while the remaining samples recognized 1-3 proteins. Among the four individuals receiving secondary vaccinations, all but one responded to a greater number of antigenic proteins recognized by IgG after vaccination compared to prevaccination. Antibody binding to O2L (glutaredoxin) and H7R, frequently observed among IgG obtained from both primary and nonvaccinated individuals, was absent in sera from secondary vaccines.

The antibody recognition of O2L and H7R was restored in serum from only one individual following secondary vaccination. Consistent with the results shown above, cluster analysis demonstrated that the eight vaccinia proteins H5R (VACVgp128), C3L (VACVgp031), I3L (VACVgp093), A27L (VACVgp188), DI3L (VACVgp150), I1L (VACVgp091), H3L (VACVgp126), and A33R (VACVgp196) group together. In addition, serum samples from vaccinated individuals clustered together while proteins from controls or prevaccinated individuals form different clusters. Conversely, antibody responses of individuals who received secondary vaccinations were similar to primary vaccinations, either before or after secondary vaccination. Vaccinated individuals appear to form two clusters associated with the eight vaccinia proteins, one more distinct from controls and naïve, another less distinct. The intensity values are highest in the strong cluster, lower in the weak cluster and lowest in controls or prevaccinated individuals. Relative levels of virus-neutralizing antibodies were examined in sera obtained from vaccinees and compared with the specific vaccinia proteins recognized by each serum. Antibody recognition of the proteins C3L, I1L, and A33R correlated with the virus-neutralizing titers obtained from primary vaccinated individuals. Antibody binding to the putative DNA-binding virion core protein I1L exhibited the greatest correlation with virus-neutralizing titers, suggesting the importance of this newly detected antigen in directing protective immunity.

An essential subset of vaccinia proteins recognized by antibodies from vaccinated humans has been identified. The identification of these antigens was facilitated by the development of a vaccinia proteome microarray comprised of purified recombinant proteins that were produced by eukaryotic-cell expression. These proteins are important biomarkers of vaccinia immunity and potential targets for the development of new orthopoxvirus vaccines. The vaccinia proteins A27L, DI3L, I1L, and H3L were recognized by antibodies from the majority of vaccinated subjects, while A33R, H5R, and C3L were bound by antibodies from over 25% of the vaccines. Antibody binding to the C3L, I1L, H5R, and DI3L was exquisitely dependent on vaccination, as antibody binding to these antigens did not occur with sera from nonvaccinated individuals.

These results suggest that the primary antibody response to individual vaccinia proteins varies from individual to individual while the total number of proteins recognized by antibodies is only slightly altered by secondary vaccination. Proteins encoded by approximately 97 vaccinia ORFs were not included in the proteome microarray due to problems with protein expression. If it is assumed that these additional proteins have the same likelihood of antibody recognition as the proteins examined in the current microarray, then perhaps five more antigens may be included, resulting in a total of about 5% of the vaccinia proteome associated with antibody responses. The number of antibody-recognized proteins may increase if the untested proteins are inherently more antigenic. A comparison of all sera tested indicates that an array consisting of the vaccinia proteins A27L, DI3L, I1L, H3L, A33R, H5R, C3L, and I3L may be sufficient for monitoring and evaluating antibody immunity to smallpox. All of the vaccinia proteins in this panel are represented by homologous or identical polypeptides present within the variola major and minor viral proteomes. In addition to the vaccinia-specific responses, antibodies that bound the arrayed proteins O2L and H7R were present in sera from several individuals, and this recognition pattern was independent of vaccination.

A recent report described a protein array that was used to measure antibody responses to vaccinia virus (Davies, et al., 2005(a), supra). The unsequenced gene clones from vaccinia were expressed in E. coli and used to create a microarray based on crude, unpurified, recombinant proteins. Several vaccinia proteins were specifically recognized by serum antibodies in this previous study, some confirmed by our analysis, though considerable background binding of antibodies was noted due to the preponderance of contaminating E. coli proteins. However, additional proteins reported here and elsewhere (Galmiche, et al., Virology 254:71-80, 1999) were not detected by immune sera in the recent report in part because the bacterial expression system used for the preparation of the microarray elements resulted in incomplete post-translational modifications of the vaccinia products. Although it is difficult to assess correct folding of microarrayed proteins, catalytic function was retained by several of the enzymatic vaccinia proteins on the arrays used in this study.

The antibody-binding proteins detected by microarray are significant biomarkers for measuring antibody responses to vaccinia, yet not all may be essential for immunity. For example, antibodies against A33R do not neutralize infection by EEV. However, immunization with A33R, a protein required for the formation of actin containing microvilli and efficient cell-to-cell spread of vaccinia virus, protected mice against a lethal virus challenge, suggesting that this protein may be more important for CTL responses. It has been reported that antibody responses remain stable for up to 75 years after vaccination, whereas T-cell immunity slowly declines, with a half-life of 8-15 years. A comparison of vaccinia protein recognition with previously published data for T-cell recognition indicates that I1L, H3L, and A27L stimulate T-cell immunity among individuals expressing the high-frequency MHC class I allele HLA-A*0201, while C3L and I3L are also reported to be T-cell antigens. It may be possible to routinely evaluate biomarkers for both cellular and antibody-mediated immunity as high-throughput methods for evaluating T-cell responses become available. Further complexity in antibody-response profiles is influenced by expression-phase variation in viral antigens presented during the infective cycle. Antibody depletion experiments previously demonstrated that the EEV surface protein B5 contributes to EEV neutralization in vaccinated humans, whereas A27L and H3L are targets for IMV-neutralizing antibodies.

The present vaccinia proteome microarray will be useful for evaluating immunity to new vaccines. The highly attenuated vaccinia virus strain, NYVAC (vP866), was derived from a plaque-cloned isolate of the Copenhagen vaccine strain by the deletion of 18 ORFs, including the complement 4b binding protein C3L. These results indicate that C3L is an antigen recognized by a significant number of individuals receiving the DRYVAX® vaccine, suggesting the contribution of this protein to protective immunity against smallpox. In addition, antigenic variations between proteins produced by smallpox virus and attenuated vaccines have not been sufficiently addressed. For example, the vaccinia virus complement control protein is nearly 100-fold less potent than the homologous smallpox inhibitor of complement enzymes at inactivating human C3b, contributing to the lower virulence of vaccinia compared to variola virus. Antibody recognition of complement control protein and other virulence factors may also differ between pathogen and vaccine.

The vaccinia proteome microarray described herein represents an important advancement over previously reported arrays in that the identity of each clone was confirmed by sequencing, the majority of all predicted proteins encoded within the viral genome were purified and arrayed, and eukaryotic cell expression increased the likelihood of nativelike proteins. Though antibody binding may not require native folding for many of the vaccinia proteins, high-content arrays of functional proteins provide a high-throughput tool for evaluating protein-protein interactions and biological activities of all elements contained within the viral proteome. Thus, a full inventory of vaccinia proteins required for optimal protection against smallpox will speed the development of safer, better-defined vaccines and will contribute substantially to devising new strategies for therapy.

### Example 7

### Microarray-Based Anthrax Model

This example describes the principles for designing an in vivo rabbit model for anthrax vaccine, antimicrobial and pathogenicity research. This model relies on nanoarray and microarray detection techniques for the generation of data on physiological responses to infection. The studies extend the usefulness of an existing rabbit anthrax model, and should accelerate the development of countermeasures against anthrax. Protein microarray technology will be utilized and a collection of approximately 5000 ORF clones from B. anthracis will be transferred into expression vectors, tested for protein expression, and purified proteins will be used to generate protein microarrays. Arraying procedures and validating genomic proteins will follow Invitrogen-established technologies. Arrays will be evaluated on samples from experimentally infected rabbits to potentially yield significant new data for pathogenicity, vaccine development, and therapeutic antimicrobial trials. The new model is expected to yield carefully defined, reproducible data useful with the Food and Drug Administration's animal rule.

Protein microarrays contain defined sets of proteins arrayed in up to 20,000 nano-dots on microscope-sized slides. It is not practical for bacteria like Bacillus anthracis, which encode thousands of proteins, to analyze each protein one at a time. The advantage of protein arrays is the ability, in a single experiment, to rapidly and simultaneously screen large numbers of proteins for biochemical activities, immunogenicity, protein-protein interactions, etc.

As noted above, the first commercially viable “whole-proteome” microarray was launched by Invitrogen Corporation in 2004. Although various protein arrays have been produced in research labs, for reproducible data, the arrays have to be produced: (1) employing rigorous quality control on the cloned genes to ensure sequence identity to reference databases; (2) using purified proteins checked for proper concentration and molecular weight; (3) using an appropriate expression host that allows post-translation modifications; (4) utilizing buffers and conditions to ensure non-denatured proteins; and (5) incorporating varied controls on each slide manufactured according to commercially acceptable specifications.

The New Zealand White rabbit is a convenient model for study using both the subcutaneous and inhalation exposure routes. This rabbit model has been used for anthrax vaccine efficacy testing, anthrax post-exposure prophylactic efficacy, and for anthrax therapeutic intervention studies. With both exposure routes, the survival rates and time-to-death of the naïve controls are very similar. Challenge doses usually approximate 100-200×LD₅₀ and survival rate of naïve controls is about 1% overall. Time-to-death in both models is about 5 days. Serial blood sampling to examine the proteins that are expressed during the course of infection and to characterize the overall response to the bacterial proteins can be performed over the entire course of the disease. In order to generate an antibody response, a sub-lethal dose or promotion of partial protection will be required. Partial protection can be assessed through the use of levofloxacin post-challenge, an antibody administered post-challenge, or a general use prophylaxis of Anthrax Vaccine Adsorbed (“AVA”) to protect rabbits prior to challenge.

These arrays may be exploited by closely integrating them into an animal model with the hope of achieving a significant increase in the amount and quality of data obtained in the rabbit anthrax model. A collection of approximately 5000 ORF clones from B. anthracis will be transferred into expression vectors, tested for protein expression, expression-validated clones will be used to generate protein microarrays, and these arrays will be validated. The protein microarrays can be used to: (1) discover, in unprecedented detail, knowledge of the quantity and quality of the humoral immune response; (2) target, for antimicrobial development, protein-protein interactions that occur between host and pathogen; and (3) expand the knowledge of molecular pathogenicity of B. anthracis. These arrays could provide significant new knowledge to accelerate the development of new vaccines, therapeutics and diagnostic assays.

Baseline immuno-reactivity data will be established by analyzing on arrays sequentially collected sera from B. anthracis infected rabbits. Samples would come from terminally ill animals, any surviving animals and controls. Animals infected by aerosol route will be compared with those infected by injection. The immunological profile (IgG, IgM) to each of the thousands of arrayed proteins will be established using rabbits immunized with established anthrax vaccines. The immunological events associated with survival of animals treated at various times post-inoculation with an antimicrobial drug will be established.

Microarrays hold the potential to gather a significant increase of new information from each sample, and thus would greatly expand the usefulness of the limited animal models available for biothreat agents. For high containment diseases, research is particularly slow and complicated. For many diseases, there are few if any readily available antimicrobials. Knowledge from studies in this model should lead to advances in the basic understanding of the virulence of B. anthracis, and consequently aid the development of antimicrobials. In those cases where a putative antimicrobial exists, often the mechanism of action is difficult to uncover. Using arrays to analyze an animal's response to infection with or without an antimicrobial could yield information on how the animal processed the infection while being treated. In regard to vaccinology, there are a number of potential anthrax vaccines under development. The ability of microarrays to quickly provide extensive comparative data from different vaccines could be very significant. Understanding the quantity and quality of the protective response these vaccines generate is of paramount importance during development.

From the description provided herein, one skilled in the art can readily ascertain the essential characteristics of this invention, and without departing from the spirit and scope thereof, can make various changes and modifications of the invention to adapt it to various usages and conditions without undue experimentation. All patents, patent applications and publications cited herein are incorporated by reference in their entirety.

1. A composition comprising ten or more proteins, each of which shares at least 10 amino acids of sequence identity with different proteins derived from one or more pathogenic agent,
wherein the proteins are each located in separate locations on a solid support.

2. The composition of claim 1, wherein the pathogenic agent is one or more pathogenic agents of a class selected from the group consisting of a protozoan, a virus, a viroid, a bacterium, and a parasitic worm.

3. The composition of claim 1, wherein the solid support contains from about two to about four thousand proteins, from about two to about three thousand proteins, from about two to about two thousand proteins, from about two to about one thousand proteins, from about one hundred to about five thousand proteins, from about one hundred to about four thousand proteins, or from about one hundred to about one thousand proteins.

4. The composition of claim 1, wherein the solid support contains proteins which share sequence identity with at least one protein from about two to about two hundred, from about two to about four hundred, from about five to about two hundred, from about ten to about two hundred, from about twenty to about two hundred, from about thirty to about two hundred, or from about forty to about two hundred different pathogenic agents.

5. The composition of claim 1, wherein one or more of the pathogenic agents is in a class selected from the group consisting of a human immunodeficiency virus, a Mycobacterium, a Chlamydia, a Shigella, a Treponema, a Rickettsia, a hemorrhagic fever virus, or a human papilloma virus.

6. The composition of claim 5, where the Mycobacterium is of a species selected from the group consisting of Mycobacterium tuberculosis, Mycobacterium szulgai, Mycobacterium smegmatis, Mycobacterium marinum, Mycobacterium bovis, Mycobacterium caprae, Mycobacterium simiae, Mycobacterium terrae, Mycobacterium neoaurum, Mycobacterium simiae, Mycobacterium avium, Mycobacterium parascrofulaceum, Mycobacterium gordonae, and Mycobacterium leprae.

7. The composition of claims 1, wherein the proteins are affixed to said solid support via covalent linkage to said support.

8. The composition of claim 1, wherein said solid support comprises a material selected from the group consisting of nitrocellulose, diazocellulose, glass, polystyrene, polyvinylchloride, polypropylene, polyethylene, polyvinyldifluoride and nylon.

9. The composition of claim 1, wherein said vectors are affixed to said solid support in such a way as to form an array.

10. A method for determining immune status of an individual with respect to three or more pathogenic agents, the method comprising:
(a) obtaining a sample from the individual,
(b) contacting the sample with a solid support, wherein the solid support contains proteins, each of which shares at least 10 amino acids of sequence identity with different proteins derived from one or more pathogenic agent, and wherein the proteins are each located in separate locations on a solid support, and
(c) identifying the binding of antibodies to locations on the solid support, thereby determining immune status.

11. A method for identifying one or more molecule which induces an immunological response in an individual, the method comprising:
(a) either (i) contacting the individual with a pathogenic agent or one or more biological material from the pathogenic agent or (ii) selecting the individual on the basis of past exposure to the pathogenic agent,
(b) obtaining a sample from the individual,
(c) contacting the sample with a solid support, wherein the solid support contains proteins, each of which shares at least 10 amino acids of sequence identity with different proteins derived from one or more pathogenic agent, and wherein the proteins are each located in separate locations on a solid support, and
(d) identifying the binding of antibodies to locations on the solid support, thereby identifying one or more molecule which induces an immunological response in the individual.

12. The method of claim 11, wherein at least one of the one or more molecule is a protein.
